(19) United States
(12) Patent Application Publication
(10) Pub. No.: US 2013/0266232 A1
(43) Pub. Date: Oct. 10, 2013

(54) ENCODING DEVICE AND ENCODING METHOD, AND DECODING DEVICE AND DECODING METHOD

(71) Applicant: Kazushi Sato, Tokyo (JP)

(72) Inventor: Kazushi Sato, Tokyo (JP)

(73) Assignee: Sony Corporation, Tokyo (JP)

(21) Appl. No.: 13/994,058

(22) PCT Filed: Jan. 6, 2012
(86) PCT No.: PCT/JP2012/050172

§ 371 Date: Jun. 13, 2013

(30) Foreign Application Priority Data
Jan. 13, 2011 (JP) 2011-005188

(51) Int. Cl. G06T 9/00

(52) U.S. Cl. CPC G06T 9/004
USPC 382/233; 382/236

(57) ABSTRACT

The present technology relates to an encoding device and encoding method, and a decoding device and decoding method, whereby encoding efficiency when performing intra prediction can be improved. A candidate prediction image generating unit 41 performs intra prediction processing as to a PU of an image to be encoded, in multiple intra prediction modes, and generates a prediction image. A prediction mode determining unit 43 determines an optimal intra prediction mode of the PU for intra prediction processing. A MostProbableMode generating unit 51 generates a MostProbableMode using a peripheral optimal intra prediction mode. A difference mode generating unit 52 generates optimal difference intra prediction mode information indicating the difference between a number of the optimal intra prediction mode of the PU for intra prediction processing and the MostProbableMode. An intra skip determining unit 45 transmits optimal difference intra prediction mode information. The present technology can be applied to an encoding device, for example.

### TECHNICAL FIELD

The present technology relates to an encoding device and encoding method, and a decoding device and decoding method, and in particular relates to an encoding device and encoding method, and a decoding device and decoding method, whereby encoding efficiency when performing intra prediction can be improved.

### BACKGROUND ART

In recent years, there have come into widespread use devices which subject an image to compression encoding by employing formats such as MPEG (Moving Picture Experts Group phase) and so forth handling image information as digital signals, and compress the image by orthogonal transform such, as discrete cosine transform or the like and motion compensation, taking advantage of redundancy peculiar to the image information, in order to perform highly effective information transmission and storage at that time,

In particular, MPEG2 (ISO/IEC 13818-2) is defined as a general-purpose image encoding format, and is a standard encompassing both of interlaced scanning images and sequential-scanning images, and standard resolution images and high definition images, and has widely been employed, now by a broad range of applications for professional usage and for consumer usage. By employing the MPEG2 compression format, a code amount, (bit rate) of 4 through 8 Mbps is allocated in the event of an interlaced scanning image of standard resolution having 720×480 pixels, and by employing the MPEG2 compression format, a code amount (bit rate) of 18 through 22 Mbps is allocated in the event of an interlaced scanning image of high resolution having 1920×1088 pixels, for example, whereby a high compression rate and excellent image quality can be realized.

With MPEG2, high image quality encoding adapted to broadcasting usage is principally taken as an object, but a lower code amount (bit rate) than the code amount of MPEG1, i.e., an encoding format having a higher compression rate is not handled. According to spread of personal digital assistants, it has been expected that needs for such an encoding format will be increased from now on, and in response to this, standardization of the MPEG4 encoding format has been performed. For example, with regard to the MPEG4 image encoding format, the specification thereof was confirmed as an international standard as ISO/IEC 14496-2 in December in 1998.

Further, in recent, years, standardization of a standard called H.26L (ITU-T Q6/16 VCEG (Video Coding Expert Group)) has progressed, intended for image encoding for videoconferencing usage. With H.26L, it has been known that as compared to a conventional encoding format such as MPEG2 or MPEG4, though greater computation amount is requested for encoding and decoding thereof, higher encoding efficiency is realized. Also, currently, as part of activity of MPEG4, standardization for also taking advantage of functions not supported by H.26L with this H.26L taken as a base, to realize higher encoding efficiency, has been performed as Joint Model of Enhanced-Compression Video Coding. As a schedule of standardization, H.264 and MPEG-4 Part10 Advanced Video Coding (hereafter, referred to as 264/AVC), became an international standard in March, 2003.

Further, as an expansion thereof, standardization of 264/AVC FRExt (Fidelity Range Extension), which includes encoding tools necessary for operations such as RGB, 4:2:2, 4:4:4, and MPEG-2 stipulated 8×8DCT (Discrete Cosine Transform) and quantization matrices, has been completed in February of 2005. Accordingly, an encoding format capable of expressing well film noise included in movies using the H.264 /AVC format has been obtained, and is to be used in a wide range of applications such as Blu-Ray Disc and so forth.

However, as of recent, there are increased needs for even further high compression encoding, such as to compress images around 4000×2000 pixels, which is fourfold that of Hi-Vision images, or such as to distribute Hi-Vision images in an environment with limited transmission capacity, such as the Internet. Accordingly, the VCEG under ITU-T is continuing study relating to improved encoding efficiency.

Now, with the H.264/AVC format there are nine types of 4×4 intra prediction modes and 8×8 intra prediction modes and four types of 16×16 intra prediction modes for luminance signal intra prediction modes, and there are four types of 8×8 intra prediction modes for color difference signal intra prediction modes. For the luminance signal 4×4 intra prediction modes and 8×8 intra prediction modes, one intra prediction mode is defined for each 4×4 pixel and 8×8 pixel luminance signal block. For luminance signal 16×16 intra prediction modes and color difference signal intra prediction modes, one prediction mode is defined for each macroblock.

Now, with the H.264/AVC format, improvement in encoding efficiency of images with even higher resolution, such as 4000×2000 pixels, can be realized by performing encoding processing with the size of macro-blocks extended to 32×32 pixels, 64×64 pixels, and so forth. An example of application of extension of macroblocks to intra slices is described in NPL 1, for example.

On the other hand, standardization of an encoding format called HEVC (High Efficiency Video Coding) has currently been advanced by JCTVC (Joint Collaboration Team Video Coding) serving as a standardization organization of collaboration between ITU-T and ISO/IEC with improvement in encoding efficiency beyond H.264/AVC as an object, and NPL 2 has been issued as a draft as of September 2010.

With the HEVC format, the number of modes of intra prediction mode has increased as compared to the H.264/AVC format, and the greatest number of modes for intra prediction mode is 34. Also, it has been proposed with the HEVC format, that in the event that the intra prediction mode of the current block for intra prediction processing-matches the MostProbableMode, a flag indicating matching is included in the image compression information, and if not matching, the intra prediction mode itself is included in the image compression information, in the same way as with the H.264/AVC format. A MostProbableMode is the smallest intra prediction mode of peripheral blocks of the current block for intra prediction processing.

### CITATION LIST

### Non Patent Literature

NPL 1: “Intra coding using extended block size”, VCEG-AL28, July, 2009

NPL 2: “Test Model under Consideration”, JCTVC-B205, 21-28 July, 2010

### SUMMARY OF INVENTION

### Technical Problem

However, with a format such as HEVC having a great number of modes for intra prediction mode, the probability that the intra prediction mode of the current block for intra prediction processing will match the MostProbableMode is low. Accordingly, in the event that the intra prediction mode of the current, block for intra prediction processing does not match the MostProbableMode, inclusion of the intra prediction mode itself in the image compression information leads to deterioration in encoding efficiency.

The present technology has been made in light of this situation, and enables encoding efficiency in the event of performing intra prediction to be improved.

### Solution to Problem

An encoding device according to a first aspect of the present technology includes: a prediction value generating unit, configured to generate, using an optimal intra prediction mode of a peripheral block situated in the periphery of a current block which is the object of encoding, a prediction value for an optimal intra prediction mode of the current block; a difference generating unit configured to generate the difference between the optimal intra prediction mode of the current block, and the prediction value of the optimal intra prediction mode of the current block generated by the prediction value generating unit; and a transmission unit configured to transmit the difference generated by the difference generating unit.

An encoding method according to the first aspect, of the present technology corresponds to the encoding device according to the first aspect of the present technology.

With the first aspect of the present technology, using an optimal intra prediction mode of a peripheral block situated in the periphery of a current block which is the object of encoding, a prediction value is generated for an optimal intra prediction mode of the current block; the difference between the optimal intra prediction mode of the current block, and the prediction value of the optimal intra prediction mode of the current block, is generated; and the difference is transmitted.

A decoding device according to a second aspect of the present technology includes: a receiving unit configured to receive difference between an optimal intra prediction mode of a current block which is the object of decoding, and a prediction value of an optimal intra prediction mode of the current block, generating using an optimal intra prediction mode of a peripheral block situated in the periphery of the current block; a prediction value generating unit configured to generate a prediction value of the optimal mode of the current block, using the optimal intra prediction mode of the peripheral block; and an intra prediction mode generating unit configured to generate the optimal intra prediction mode of the current block, by computing the difference received by the receiving unit and the prediction value of the optimal intra prediction mode of the current block, generated by the prediction value generating unit.

A decoding method according to the second aspect of the present technology corresponds to the decoding device according to the second aspect of the present technology.

With the second aspect of the present technology, difference between an optimal intra prediction mode of a current block which is the object of decoding, and a prediction value of an optimal intra prediction mode of the current block generating using an optimal intra prediction mode of a peripheral block situated in the periphery of the current block, is received; a prediction value of the optimal mode of the current block is generated, using the optimal intra prediction mode of the peripheral block; and the optimal intra prediction mode of the current block is generated, by computing the difference and the prediction value of the optimal intra prediction mode of the current block.

Note that the encoding device according to the first, aspect and the decoding device according to the second, aspect can be realized by causing a computer to execute a program.

Also, in order to realize the encoding device according to the first aspect and the decoding device according to the second aspect, the program to be executed by the computer can be provided by being transmitted via a transmission medium or recorded in a recording medium.

### Advantageous Effects of Invention

According to the first aspect, of the present, technology, encoding efficiency in a case of performing intra prediction can be improved.

According to the second aspect of the present technology, an image encoded such that encoding efficiency in a case of performing intra prediction is improved, can be decoded.

### BRIEF DESCRIPTION OF DRAWINGS

FIG. 1 is a block diagram illustrating a configuration example of an embodiment of an encoding device to which the present technology has been applied.

FIG. 2 is a block diagram illustrating a configuration example of the intra prediction unit and prediction mode encoding unit in FIG. 1.

FIG. 3 is a diagram for describing CUs.

FIG. 4 is a first diagram for describing intra prediction processing.

FIG. 5 is a second diagram for describing intra prediction processing.

FIG. 6 is a diagram for describing numbers of intra prediction modes.

FIG. 7 is a flowchart for describing encoding processing -with the encoding device in FIG. 1.

FIG. 8 is a flowchart for describing encoding processing with the encoding device in FIG. 1.

FIG. 9 is a flowchart for describing the details of prediction processing in FIG. 7.

FIG. 10 is a block diagram illustrating a configuration example of a decoding device to which the present technology has been applied.

FIG. 11 is a block diagram illustrating a configuration example of the intra prediction unit and prediction mode decoding unit in FIG. 10.

FIG. 12 is a flowchart for describing decoding processing with the decoding device in FIG. 10.

FIG. 13 is a flowchart for describing the details of prediction processing in FIG. 12.

FIG. 14 is a block diagram illustrating a configuration example an embodiment of a computer.

FIG. 15 is a block diagram illustrating a principal configuration example of a television receiver.

FIG. 16 is a block diagram illustrating a principal configuration example of a cellular telephone.

FIG. 17 is a block diagram illustrating a principal configuration example of a hard disk recorder.

FIG. 18 is a block diagram illustrating a principal configuration example of a camera.

### DESCRIPTION OF EMBODIMENTS

### Embodiment

### Configuration Example of Embodiment of Encoding Device

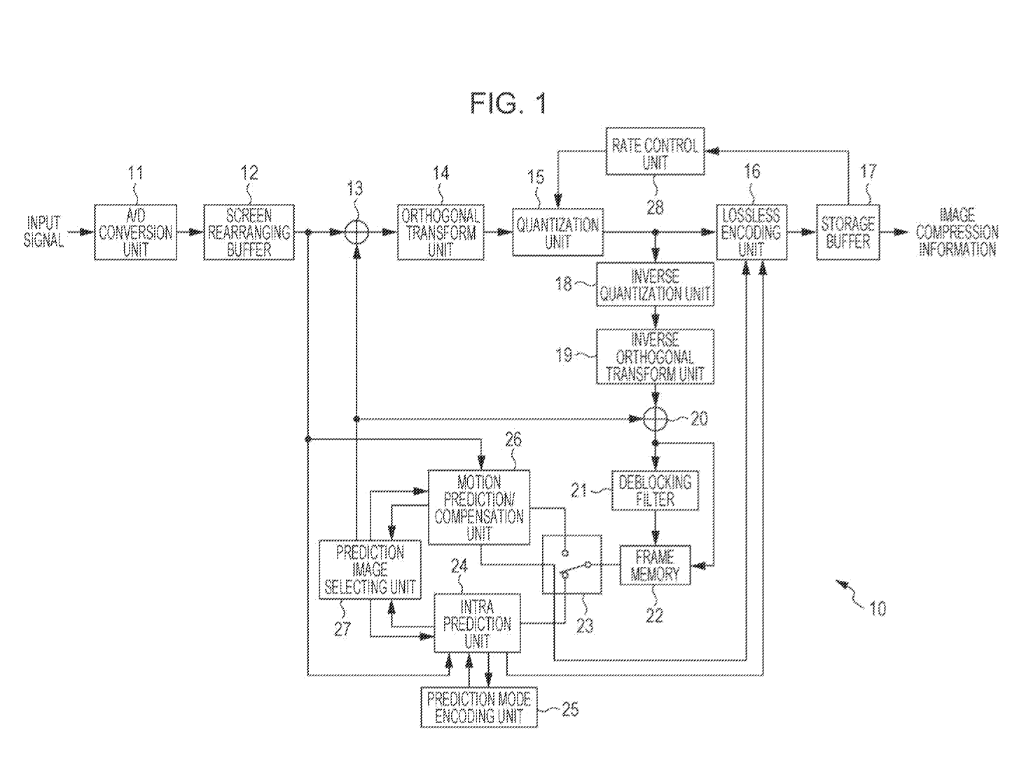

FIG. 1 is a block diagram illustrating a configuration example of an embodiment of an encoding device to which the present technology has been applied.

The encoding device 10 in FIG. 1 has an A/D conversion unit 11, a screen rearranging buffer 12, a computing unit 13, an orthogonal transform unit 14, a quantization unit 15, a lossless encoding unit 16, a storage buffer 17, an inverse quantization unit 18, an inverse orthogonal transform unit 19, an adding unit 20, a deblocking filter 21, frame memory 22, a switch 23, an intra prediction unit 24, prediction mode encoding unit 25, a motion prediction/compensation unit 26, a prediction image selecting unit 27, and a rate control unit 28. The encoding device 10 in FIG. 1 performs compression encoding of the input image by the HEVC format.

Specifically the A/D conversion unit 11 of the encoding device 10 performs A/D conversion of an input image input as input signals in frame increments, and outputs to the screen rearranging buffer 12 and stores. The screen rearranging buffer 12 rearranges the images in frame increments in the stored order for display into the order of frames for encoding according to GOP (Group of Picture) structure, and outputs to the computing unit 13, intra prediction unit 24, and motion prediction/compensation unit. 26.

The computing unit 13 functions as a generating unit, and computes (generates) the difference between the prediction image supplied from, the prediction image selecting unit 27 and the image to be encoded output, from the screen rearranging buffer 12. Specifically, the computing unit 13 subtracts, from the image output from the screen rearranging buffer 12, the prediction image supplied from the prediction image selecting unit 27. The computing unit 13 outputs an image obtained, as the results of the subtraction, as residual information (residual image) thereof to the orthogonal transform unit 14. Note that if no prediction image is supplied from the prediction image selecting unit 27, the computing unit 13 outputs the image read out from the image screen rearranging buffer 12 to the orthogonal transform unit 14 as it is, as residual information.

The orthogonal transform unit 14 subjects the residual information from the computing unit 13 to orthogonal transform, such as DCT (Discrete Cosine Transform), KLT (Karhunen Loeve Transform), or the like, and supplies a transform coefficient, obtained as the result of orthogonal transform to the quantization unit 15.

The quantization unit 15 quantizes the coefficient supplied from the orthogonal transform unit 14. The quantized coefficient is input to the lossless encoding unit 16.

The lossless encoding unit 16 obtains a number of an optimal intra prediction mode for the block (unit) to be subjected to intra prediction processing, and information indicating difference of a MostProbableMode defined by the following Expression (1) (hereinafter referred to as optimal difference intra prediction mode information) from, the intra prediction unit 24.

MostProbableMode=Mini Intra_{—}4×4_pred_modeA, Intra_{—}4×4_pred_modeB) (1)

Note that in Expression (1), Intra_{—}4×4_pred_modeA is the number of the optimal intra prediction mode of block A adjacent to the block C to be subjected to intra prediction processing at the left, and Intra_{—}4×4_pred_modeB is the number of the optimal intra prediction mode of block. B adjacent to block C above.

According to Expression (1), the smaller number of the optimal intra prediction mode numbers of block A and block B is taken as the MostProbableMode.

Note that block A and block B do not have to be adjacent, as long as in the periphery of block C.

Also, information indicating the optimal inter prediction mode (hereinafter referred to as inter prediction mode information), motion vectors, information for identifying a reference image, and so forth, are obtained from the motion prediction/compensation unit 26.

The lossless encoding unit 16 encodes the quantized transform coefficient supplied from the quantizing unit 15, performs lossless encoding processing, such as variable length coding (e.g., CAVLC (Context-Adaptive Variable Length Coding)), arithmetic coding (e.g., CABAC (Context-Adaptive Binary Arithmetic Coding)), or the like, and takes information obtained as the result thereof as a compressed image. The lossless encoding unit 16 also performs lossless encoding of optimal difference intra prediction mode information, inter prediction mode information, motion vectors, information identifying a reference image, and so froth, and takes the information obtained as the result thereof as header information to be added to the compressed image.

Note that while with the present embodiment, optimal difference intra prediction mode information is not included in the header information in the event that the optimal difference intra prediction mode information is 0, an arrangement may be made where this is included. Also, with the present embodiment, in the event that the optimal difference intra prediction mode information and coefficient obtained as the result of orthogonal transform by the orthogonal transform unit 14 are 0, the operation mode is set to intra skip mode, and compression image and header information are not generated, but an arrangement may be made where these are generated.

The lossless encoding unit 16 functions as part of a transmitting unit, and outputs the compressed image to which header information and the like obtained as a result of lossless encoding has been added, as image compression information, to the storage buffer 17 for storing.

The storage buffer 17 temporarily stores the image compression information supplied from the lossless encoding unit 16, and transmits to, for example, a recording device or transmission path or the like downstream not shown in the drawing.

Also, the quantized transform coefficient output from the quantization unit 15 is also input to the inverse quantization unit 18, inversely quantized, and then supplied to the inverse orthogonal transform unit 19.

The inverse orthogonal transform unit 19 subjects the coefficient supplied from the inverse quantization unit 18 to inverse orthogonal transform such as IDCT (Inverse Discrete Cosine Transform), inverse KLT, or the like, and supplies the residual information obtained as the result thereof to the adding unit 20.

The adding unit 20 adds the residual information serving as the image to be decoded that is supplied from the inverse orthogonal transform unit 19 and the prediction image supplied from the prediction image selecting unit 27, and obtains a locally decoded image. In the event that no prediction image is supplied from the prediction image selecting unit 27, the adding unit 20 takes the residual information supplied from the inverse orthogonal transform unit 19 as the locally decoded image. The adding unit 20 supplies the locally decoded image to the deblocking filter 21, and also supplies this to the frame memory 22 so as to be stored.

The deblocking filter 21 removes block noise of the decoded image, by performing filtering of the locally decoded image supplied from the adding unit 20. The deblocking filter 21 supplies the image obtained as a result, thereof to the frame memory 22 for storing. The image stored in the frame memory 22 is output to the intra prediction unit 24 or motion prediction/compensation unit 26 via the switch 23 as a reference image.

The intra prediction unit 24 uses the reference image read out from the frame memory 22 via the switch 23 to perform intra prediction processing of a format called ADI (Arbitrary Direction Intra) of all candidate intra prediction modes, and generates prediction images.

Note that with the HEVC format, there are provided as intra prediction increment sizes, 4×4 pixels, 8×8 pixels, 16×16 pixels, 32×32 pixels, and 64×64 pixels. Accordingly, the candidate intra prediction modes are the 4×4 intra prediction mode, 8×8 intra prediction mode, 16×16 intra prediction mode, 32×32 intra prediction mode, and 64×64 intra prediction mode. Note that while only description of intra prediction processing of luminance signals in intra prediction mode will be described below, but intra prediction processing of color difference signals in intra prediction mode is performed in the same way.

Also, the intra prediction unit 24 calculates cost function values (described in detail later) for all of the candidate intra prediction modes, using the image read out from the screen rearranging buffer 12, and the prediction image and so forth. The intra prediction unit 24 decides the intra prediction mode of which the cost function value is the smallest to be the optimal intra prediction mode. The intra prediction unit 24 supplies the prediction image generated in the optimal intra prediction mode, and the cost function value corresponding thereto, to the prediction image selecting unit 27. In the event the intra prediction unit 24 receives notification of selection of a prediction image generated in the optimal intra prediction mode from the prediction image selecting unit 27, the intra prediction unit 24 supplies optimal difference intra prediction mode information to the lossless encoding unit 16.

Note that the cost, function value is also called RD (Rate Distortion) cost. The cost function value is calculated based on either technique of High Complexity mode or Low Complexity mode stipulated in reference software for H.264/AVC format called JM (Joint Model), disclosed at http://iphome.hhi.de/suehring/tml/index.htm, for example.

Specifically, in the event that the High Complexity Mode is to be used as the cost function value calculating technique, up to lossless encoding is tentatively performed for all candidate prediction modes, and the cost function represented with the following Expression (2) is calculated for each prediction mode.

Cost (Mode ∈ Ω)=D+λ·R (15)

Note that in Expression (2), Ω is the whole set of candidate prediction modes, D is difference energy between the original image and decoded image, R is the total code amount in the case of encoding with the each prediction mode, including orthogonal transform coefficients, and λ is a Lagrange multiplier given as a function of a quantization parameter QP.

That is to say, in order to perform encoding with the High Complexity Mode, there is the need to perform, tentative encoding processing for the prediction modes in order to calculate D and R, requiring a greater amount, of computations.

On the other hand, in the event that the Low Complexity Mode is to be used as the cost function value calculating technique, generating of a decoded image and calculation of header bits such as information indicating the prediction mode is performed for all candidate prediction modes, and the cost, function represented with the following Expression (3) is performed for each prediction mode.

Cost (Mode ∈ Ω)=D+QP2Quant(QP)·Header_Bit (3)

In Expression (3), D is the difference energy between the original image and prediction image, Header_Bit is the code amount relating to information belonging to the header not including orthogonal transform coefficients, such as motion vectors and prediction mode, and QP2Quant is given as a function of a quantization parameter QP.

That is to say, in the Low Complexity mode, prediction processing needs to be performed relating to each candidate mode, but there is no need to generate a decoded image, so there is no need, to perform tentative encoding,

As a result, less computation amount is needed.

Due to the cost function value being obtained in this way, in a case where encoding processing is performed with a prediction mode where the cost function value is the smallest, even higher encoding efficiency can be realized.

Also, the intra prediction unit 24 supplies the optimal prediction mode of encoded blocks in the periphery of the block (unit) to be subjected to intra prediction processing (hereinafter, referred to as peripheral optimal intra prediction mode), and a candidate prediction mode which is a candidate for the current intra prediction mode, to the prediction mode encoding unit 25.

The prediction mode encoding unit 25 uses the peripheral optimal intra prediction mode and candidate intra prediction mode supplied from the intra prediction unit 24, and generates difference inter prediction mode information indicating the difference in numbers between the MostProbableMode and candidate intra prediction mode. The prediction mode encoding unit 25 supplies the generated difference intra prediction mode information to the intra prediction unit 24.

The motion prediction/compensation unit 26 performs motion prediction/compensation of all candidate modes. Specifically, the motion prediction/compensation unit 26 detects motion vectors of all candidate inter prediction modes, based on the image supplied from the screen rearranging buffer 62 and the reference image read out from the frame memory 22 via the switch 23. The motion prediction/compensation unit 26 then subjects the reference image to compensation processing based on the motion vectors, and generates a prediction image.

At this time, the motion prediction/compensation unit 26 calculates a cost function value for all candidate inter prediction modes, and decides the inter prediction mode with the smallest cost function value to be the optimal inter prediction mode. The motion prediction/compensation unit 26 then supplies the cost function value of the optimal inter prediction mode and the corresponding prediction image to the prediction image selecting unit 27. In the event of being notified from the prediction image selecting unit 27 that the prediction image generated in the optimal inter prediction mode has been selected, the motion prediction/compensation unit 26 outputs inter prediction mode information, corresponding motion vector, information identifying the reference image, and so forth, to the lossless encoding unit 16.

The prediction image selecting unit 27 decides, of the optimal inter prediction mode and optimal inter prediction mode, the one with the smaller corresponding cost function value, based on the cost function values supplied from the intra prediction unit 24 and motion prediction/compensation unit 26. Thus, the one with the smaller cost, function value is decided as the optimal prediction mode, so higher encoding efficiency can be realized. Also, the prediction image selecting unit 27 supplies the prediction image of the optimal prediction mode to the computing unit 13 and adding unit 20. The prediction image selecting unit 27 notifies selection of the prediction image of the optimal prediction mode to the intra prediction unit 24 or motion prediction/compensation unit 26.

The rate control unit 28 controls the rate of quantization operations of the quantization unit 15 based on the image compression information stored in the storage buffer 17, so that overflow or underflow does not occur.

### Configuration Example of Intra Prediction Unit and Prediction Mode Encoding Unit

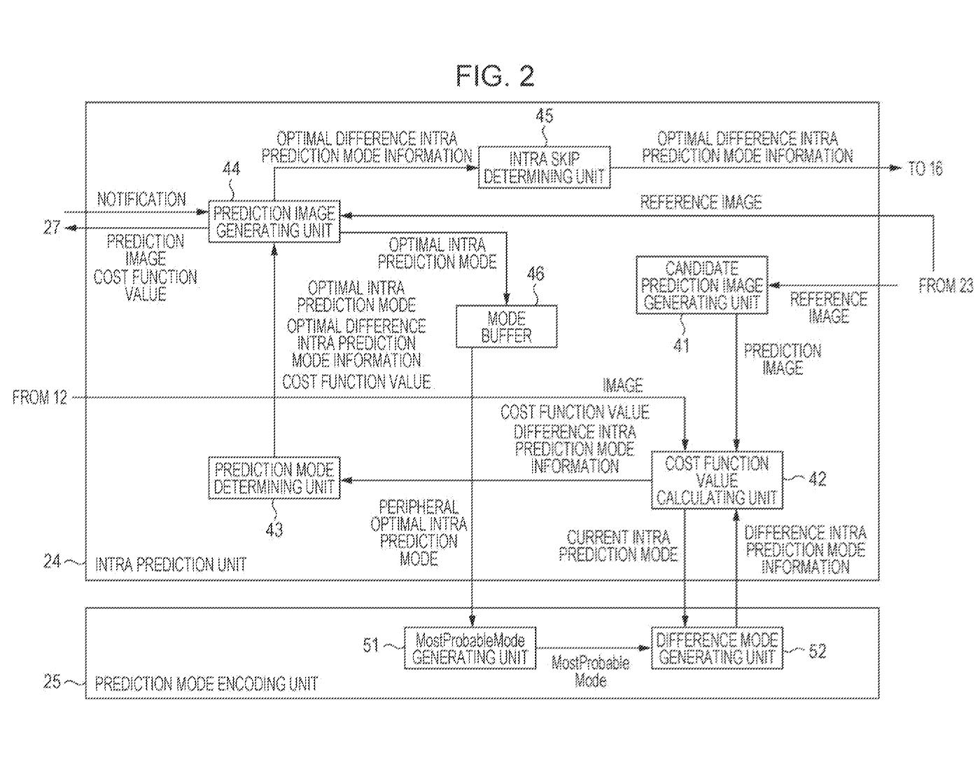

FIG. 2 is a block, diagram illustrating a configuration example of the intra prediction unit 24 and the prediction mode encoding unit 25 in FIG. 1.

As illustrated in FIG. 2, the intra prediction unit 24 is configured of a candidate prediction image generating unit 41, a cost function value calculating unit 42, a prediction mode determining unit 43, a prediction image generating unit 44, an intra skip determining unit 45, and a mode buffer 46.

The candidate prediction image generating unit 41 of the intra prediction unit 24 takes all candidate intra prediction modes, in order, as the intra prediction mode for the current inter prediction processing (hereinafter referred to as current intra prediction mode). Note that the candidate prediction image generating unit 41 performs intra prediction processing of the current intra prediction mode on each block of a predetermined size in the image to be encoded, using the reference image read out via the switch 23 in FIG. 1. The candidate prediction image generating unit 41 supplies the prediction image obtained as the result thereof to the cost function value calculating unit 42.

The cost function value calculating unit 4 2 obtains a cost, function value by the above-described Expression (2) or Expression (3), based on the prediction image supplied from the candidate prediction image generating unit 41 and the image supplied from the screen rearranging buffer 12. Also, the cost function value calculating unit 42 supplies the current intra prediction mode to the prediction mode encoding unit 25. Further, the cost function value calculating unit 42 supplies the obtained cost function value and the difference intra prediction mode information supplied from the prediction mode encoding unit 25 to the prediction mode determining unit 43.

The prediction mode determining unit 43 stores the cost function information and difference intra prediction mode information supplied from, the cost, function value calculating unit 42 in a correlated manner with the current, intra prediction mode. The prediction mode determining unit 43 decides the intra prediction mode corresponding to the smallest value of the cost function values stored correlated with all candidate intra prediction modes, to be the optimal intra prediction mode. The prediction mode determining unit 43 supplies the optimal intra prediction mode, and the optimal difference intra prediction mode information and cost, function value which are difference intra prediction mode information stored correlated to that optimal intra prediction mode, to the prediction image generating unit 44.

The prediction image generating unit 44 performs intra prediction processing of the optimal intra prediction mode supplied from the prediction mode determining unit 43, on each block of a predetermined size of the image to be encoded, using the reference image supplied via the switch 23. The prediction image generating unit 44 then supplies the prediction image obtained as a result, of the intra prediction processing, and the cost function value supplied from the prediction mode determining unit 43, to the prediction image selecting unit 27 (FIG. 1). Also, in the event that notification of selection of the prediction image generated in the optimal intra prediction mode is made from the prediction image selecting unit 27, the prediction image generating unit. 44 supplies the optimal difference intra prediction mode information supplied from the prediction mode determining unit 43 to the intra skip determining unit 45. Further, the prediction image generating unit 44 supplies the optimal intra prediction mode to the mode buffer 46.

The intra skip determining unit 45 functions as a part of a transmission unit, and in the event, that the optimal difference intra prediction mode information supplied from the prediction image generating unit. 44 is not 0, outputs the optimal difference intra prediction mode information to the lossless encoding unit 16 illustrated in FIG. 1. On the other hand, in the event that the optimal difference intra prediction mode information is 0, the intra skip determining unit 45 stops output of the optimal difference intra prediction mode information to the lossless encoding unit 16. As a result, in the event that the optimal difference intra prediction mode information is 0, the optimal difference intra prediction mode information is not included in the header information, and in the event that the optimal difference intra prediction mode information is 0 and the coefficient obtained from the orthogonal transform, unit 14 is 0, no image compression information is generated.

The mode buffer 46 holds optimal intra prediction information supplied from the prediction image generating unit 44.

The prediction mode encoding unit 25 is configured of a MostProbableMode generating unit 51 and a difference mode generating unit 52.

The MostProbableMode generating unit 51 of the prediction mode encoding unit 25 reads out the peripheral optimal intra prediction mode from the mode buffer 46. The MostProbableMode generating unit 51 functions as a prediction value generating unit, and uses the peripheral optimal intra prediction mode that has been read out to generate the MostProbableMode defined in the above-described Expression (1) as the prediction value of the optimal intra prediction mode for the block which is the object of the intra prediction processing. The MostProbableMode generating unit 51 then supplies the MostProbableMode to the difference mode generating unit 52.

The difference mode generating unit 52 functions as a difference generating unit, and generates the difference between the MostProbableMode supplied, from the MostProbableMode generating unit 51 and the current intra prediction mode supplied from the cost, function value calculating unit 42 of the intra prediction unit 24, as difference intra prediction mode information. Specifically, with the current intra prediction mode as CurrMode, the difference mode generating unit 52 generates CurrMode—MostProbableMode as the difference intra prediction mode information. The difference mode generating unit 52 then supplies the generated difference intra prediction mode information to the cost, function value calculating unit 42.

### [Description of Encoding Units in HEVC Format]

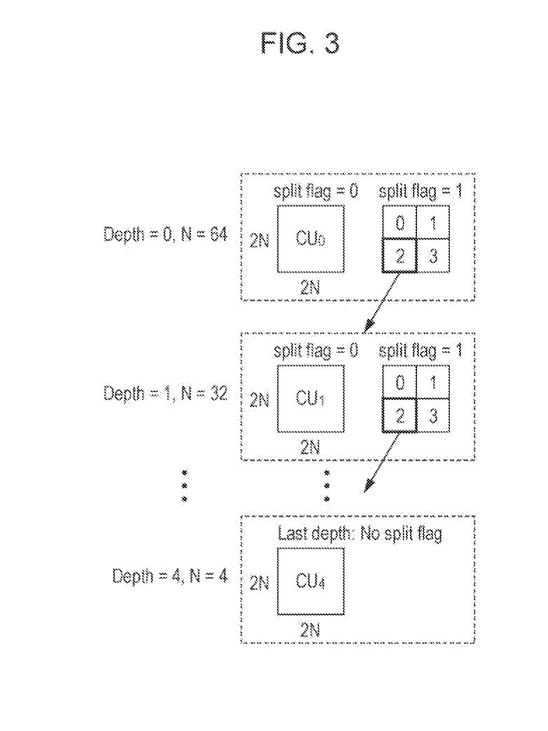

FIG. 3 is a diagram describing Coding UNITs (CUs) which are encoding units with the HEVC format.

A CU is also called a Coding Tree Block (CTB), and serves the same role as a macroblock in H.264/AVC. Specifically, a CPU is divided into Prediction Units (Pus) which are units for intra prediction or inter prediction, and divided into Transform Units (TUs) which are units of orthogonal transform.

Note however, that while macroblocks are fixed to 16×16 pixels, the CPU size is a square represented by a power of 2, variable for each sequence.

With the example in FIG. 3, the size of the LCU (Largest Coding Unit) which is the largest size CU is 128, and the size of the SCU (Smallest Coding Unit) which is the smallest size CU is 8. Accordingly, the depth of hierarchical levels (depth) of 2N×2N sizes formed in to a hierarchy for each N is 0 through 4, so the depth of hierarchical levels is 5. Also, in the event that the value of split_flag is 1 for a 2N×2N size CU, this is divided into a N×N size CU which is one hierarchical level below.

Note that information for specifying the size of CUs is included in the image compression information as a parameter set.

### [Description of Intra Prediction Processing]

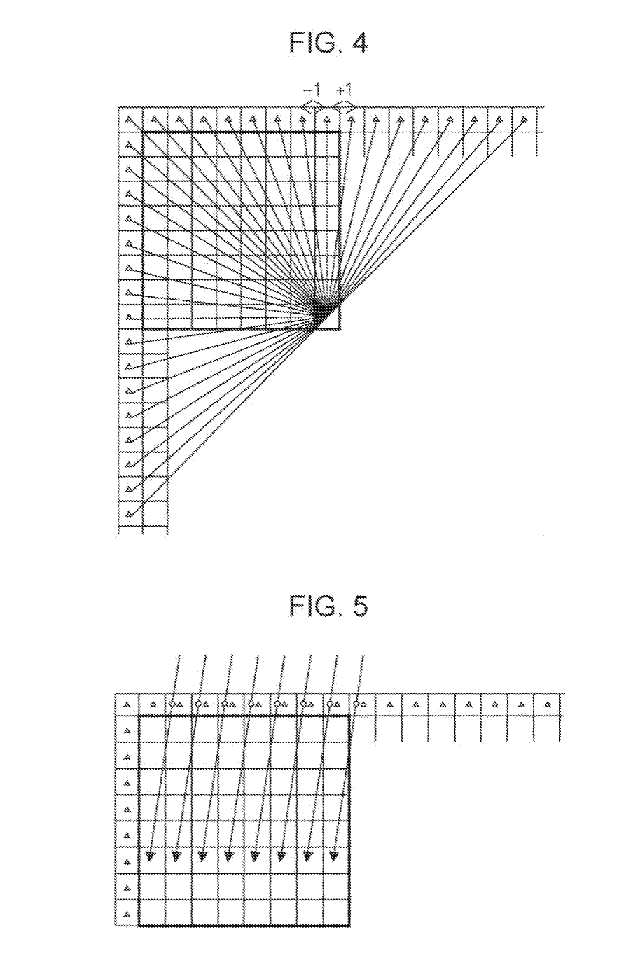

FIG. 4 and FIG. 5 are diagrams for describing intra prediction processing by the intra prediction unit 24 in FIG. 1.

In the examples in FIG. 4 and FIG. 5, the size of the PU for intra prediction is 8×8 pixels. Also, the squares in the drawings represent pixels, and the heavy lines represent the PU which is the object of the intra prediction processing.

With the processing according to the format called ADI performed by the intra prediction unit 24, in the event that the size of the PU is 8×8 pixels, intra prediction processing is performed in intra prediction modes corresponding to 33 directions of angles based on the horizontal direction or vertical direction as illustrated in FIG. 4. In this case, in order to perform intra prediction processing in optional inter prediction modes using decoded peripheral pixels which the squares denoted by triangles in FIG. 5 indicate, peripheral pixels in ⅛-pixel increments are necessary. Accordingly, the intra prediction unit 24 performs linear interpolation processing of ⅛-pixel precision in the intra prediction processing.

As illustrated in FIG. 4 and FIG. 5, the number of intra prediction modes for intra prediction processing is great with the HEVC format. Accordingly, the probability that the MostProbableMode and the optional intra prediction mode of the PU for intra prediction processing will not match is greater than with the conventional H.264/AVC format.

For example, in the event that the number of intra prediction modes is 33 for example, the step of angle corresponding to the intra prediction modes, with the horizontal direction or vertical direction as a reference, is 5.625°. Accordingly, even if the angle difference between the peripheral PUs of the PU for intra prediction processing and the PU for intra prediction processing with the horizontal direction or vertical direction as a reference is small, like 5.625°. The MostProbableMode and optimal intra prediction mode will differ with the HEVC format. For example, in the event that the angle difference between the peripheral PUs of the PU for intra prediction processing and the PU for intra prediction processing with the horizontal direction or vertical direction as a reference 11.25° and 22.5°, respectively, the MostProbableMode and optimal intra prediction mode will differ.

Accordingly, the encoding device 10 includes the optimal difference intra prediction mode information indicating the difference in numbers between the MostProbableMode and optimal intra prediction mode of the PU for intra prediction processing, in the image compression information. Accordingly, even in the event that the MostProbableMode and optimal intra prediction mode of the PU for intra prediction processing do not match, the amount of information indicating the optimal intra prediction mode can be reduced. As a result, encoding efficiency improves.

### [Description of Number of Intra Prediction Mode]

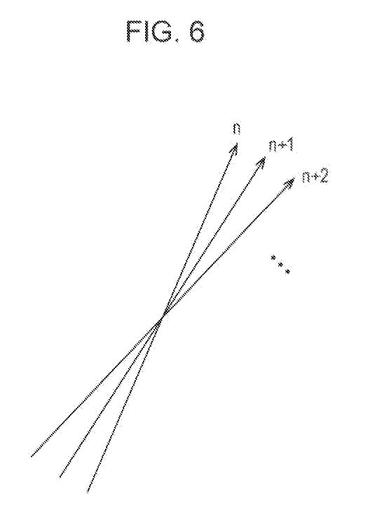

FIG. 6 is a diagram describing numbers of intra prediction modes.

As illustrated in FIG. 6, the numbers (code number) of the intra prediction modes are allocated such that the numbers of intra prediction modes adjacent in the direction of the prediction image as to the PU to be subjected to intra prediction processing, are serial.

Accordingly, in the event that the direction corresponding to the MostProbableMode and the direction corresponding to the optimal intra prediction mode of the PU for intra prediction processing are close, the amount of information of the optimal difference intra prediction mode can be reduced. For example, in the event that the angle difference between the peripheral PUs of the PU for intra prediction processing and the PU for intra prediction processing with the horizontal direction or vertical direction as a reference 11.25° and 22.5°, respectively, the optimal difference intra prediction mode information will be 2.

### [Description of Processing of Encoding Device]

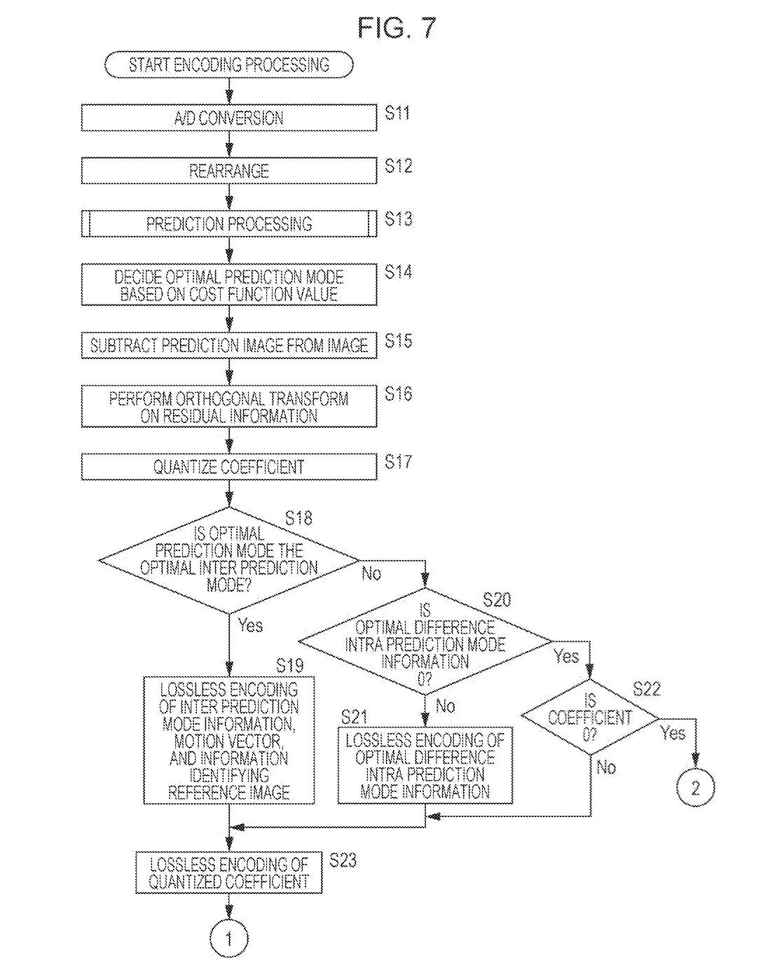

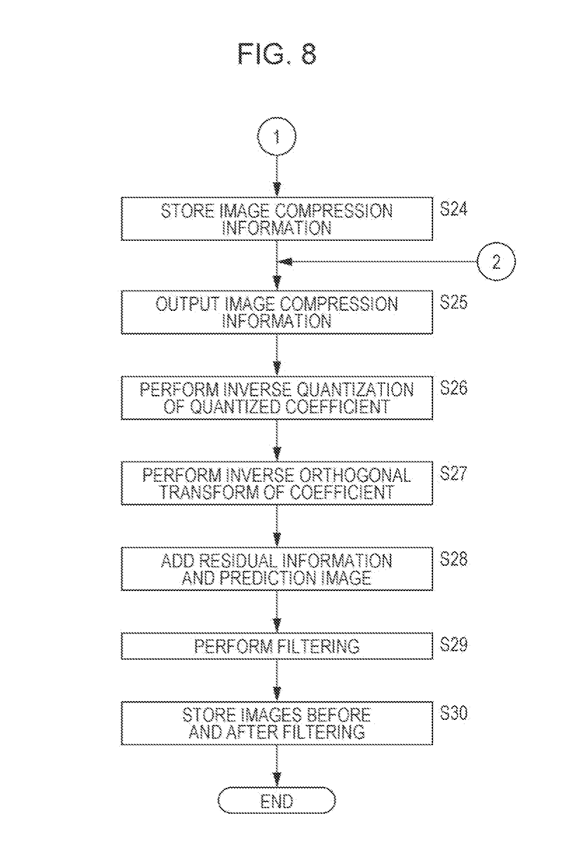

FIG. 7 and FIG. 8 are flowcharts for describing encoding processing by the encoding device 10 in FIG. 1. This encoding processing is performed each time an image in a frame increment is input to the encoding device 10 as input signals, for example.

In step S11 in FIG. 7, the A./D conversion unit 11 of the encoding device 10 performs A./D conversion of the image in a frame increment input as input signals, and outputs to the screen rearranging buffer 12 so as to be stored.

In step S12, the screen rearranging buffer 12 rearranges the images stored in the order of frames for display, in accordance with GOP structure, into order for encoding. The screen rearranging buffer 12 supplies the image in frame increments after rearranging, to the computing unit 13, intra prediction unit 24, and motion prediction/compensation unit 26.

Note that the processing in the steps S13 through S19 and S25 through S30 below is performed in increments of CUs, for example. Note however, in the event that no reference image exists, the processing of steps S13 through S15 and S25 is not performed, and the image output from the screen rearranging buffer 12 is taken as residual information and a locally decoded image.

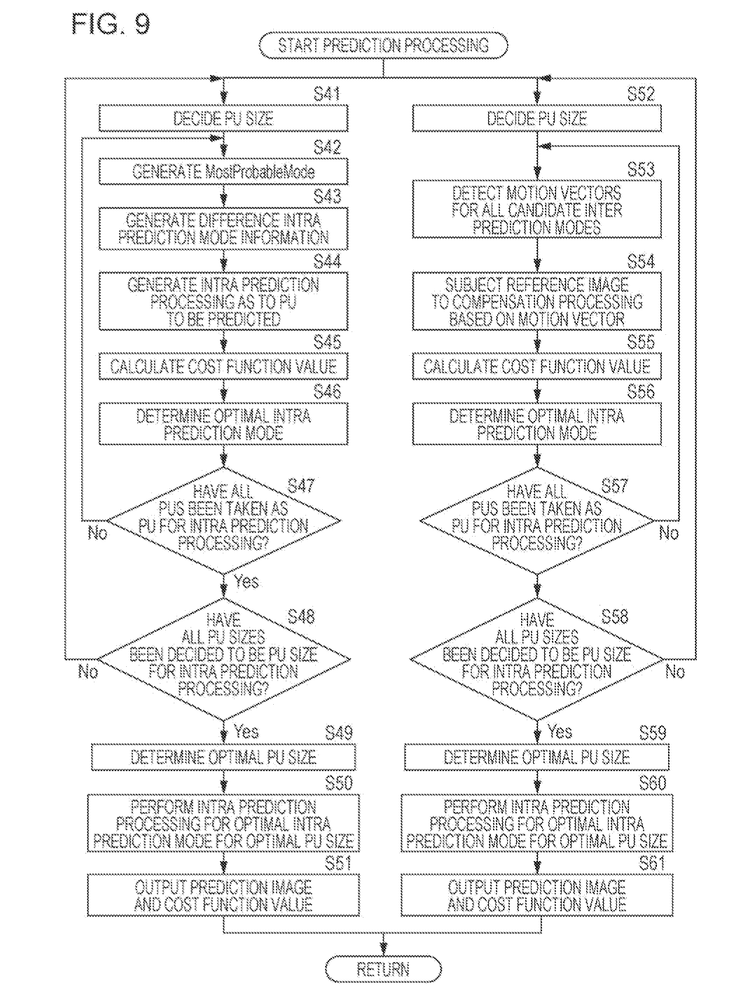

In step S13, the encoding device 10 performs prediction processing including intra prediction processing and inter prediction processing. Details of the prediction processing will be described later with reference to FIG. 9.

In step S14, the prediction image selecting unit 27 decides the smaller cost function value of the optimal intra prediction mode and optimal inter prediction mode to be the optimal prediction mode, based on the cost, function values supplied from the intra prediction unit 24 and motion prediction/compensation unit 26 in the processing in step S13. The prediction image selecting unit 27 then supplies the prediction image of the optimal prediction mode to the computing unit 13 and the adding unit 20.

In step S15, the computing unit 13 subtracts the prediction image supplied from, the prediction image selecting unit 27, from the image supplied from the screen rearranging buffer 12. The computing unit 13 outputs the image obtained as a result of the subtraction to the orthogonal transform unit 14 as residual information.

In step S16, the orthogonal transform unit 14 subjects the residual information from, the computing unit 13 to orthogonal transform such as DCT, KLT, etc., and supplies the coefficient, obtained as a result thereof to the quantization unit 15.

In step S17, the quantization unit 15 quantizes the coefficient supplied from the orthogonal transform unit 14. The quantized coefficient is input to the lossless encoding unit 16 and inverse quantization unit 18.

In step S18, the prediction image selecting unit 27 determines whether the optional prediction mode is the optimal inter prediction mode. In the event, that determination is made in step S18 that, the optional prediction mode is the optimal inter prediction mode, the prediction image selecting unit 27 notifies the selection of the prediction image generated in the optimal inter prediction mode to the motion prediction/compensation unit 26. Accordingly, the motion prediction/compensation unit 26 outputs inter prediction mode information, corresponding motion vectors, and information for identifying reference image, to the lossless encoding unit 16.

Next in step S19, the lossless encoding unit 16 performs lossless encoding of the intra prediction mode information, corresponding motion vectors, and information for identifying reference image, supplied from, the motion prediction/compensation unit 26, and the flow advances to step S23.

On the other hand, in the event that determination is made in step S18 that the optional prediction mode is not the optimal inter prediction mode, i.e., the optimal prediction mode is the optimal intra prediction mode, the prediction image selecting unit 27 notifies the selection of the prediction image generated in the optimal intra prediction mode to the intra prediction unit 24. Accordingly, the prediction image generating unit 44 of the cost, function value calculating unit 42 (FIG. 2) supplies the optimal difference intra prediction mode information supplied from the prediction mode determining unit 43 to the intra skip determining unit 45 in the processing in step S13.

In step S20 then, the intra skip determining unit 45 determines whether or not the optimal difference intra prediction mode information supplied from the prediction image generating unit 44 in PU increments is 0.

In the event that determination is made in step S20 that, the optimal difference intra prediction mode information is not 0, the intra skip determining unit 45 outputs the optimal difference intra prediction mode information to the lossless encoding unit 16, and the flow advances to step S21.

In step S21, the lossless encoding unit 16 performs lossless encoding of the optimal difference intra prediction mode information supplied from the intra prediction unit 24, and the flow advances to step S23.

On the other hand, in the event that determination is made in step S20 that, the optimal difference intra prediction mode information is 0, in step S22 the lossless encoding unit 16 determines in PU increments whether or not the coefficient obtained in the processing in step S16 is 0. In the event that determination is made in step S22 that the coefficient is not 0, the intra skip determining unit 45 stops output of the optimal difference intra prediction mode information to the lossless encoding unit 16 in PU increments, and the flow advances to step S23.

In step S23, the lossless encoding unit 16 performs lossless encoding of quantized coefficients supplied from the quantization unit 15, and takes the information obtained as the result thereof as a compressed, image. The lossless encoding unit 16 then generates image compression information by adding the information subjected to lossless encoding in step S19 or S21 to that compressed image, and supplies this to the storage buffer 17.

In step S24 in FIG. 8, the lossless encoding unit 16 supplies the image compression information in PU increments to the storage buffer 17 so as to be stored. The flow then advances to step S25.

On the other hand, in the event that determination is made in step S22 that, the coefficient is not 0, the intra skip determining unit 45 stops output of the optimal difference intra prediction mode information to the lossless encoding unit 16 in PU increments. Also, by stopping lossless encoding of the quantized coefficients supplied form the quantization unit 15 in PU units, the lossless encoding unit 16 stops output of compressed images. As a result image compression information is not stored in the storage buffer 17, and the flow advances to step S25.

In step S25, the storage buffer 17 outputs the stored image compression information in CU increments, to a recording device or transmission path or the like downstream not shown in the drawings.

In step S26, the inverse quantization unit 18 performs inverse quantization of the quantized coefficient supplied from the quantization unit 15.

In step S27, the inverse orthogonal transform unit 19 subjects the coefficient supplied from the inverse quantization unit 18 to inverse orthogonal transform such as IDCT, inverse KLT, or the like, and supplies residual information obtained as a result thereof to the adding unit 20.

In step S28, the adding unit 20 adds the residual information supplied from, the inverse orthogonal transform unit 19 and the prediction image supplied from the prediction image selecting unit 27, and obtains a locally decoded image. The adding unit 20 supplies the obtained image to the deblocking filter 21, and also supplies to the frame memory 22.

In step S29, the deblocking filter 21 removes block noise by performing filtering on the locally decoded image supplied from the adding unit 20, and stores this in the frame memory 22.

In step S30, the frame memory 22 stores images before and after filtering. Specifically, the frame memory 22 stores an image supplied from the adding unit. 20 and an image supplied from the deblocking filter 21. The images stored in the frame memory 22 are output to the intra prediction unit 24 or motion prediction/compensation unit 26 via the switch 23, as reference images. The flow ends here.

FIG. 9 is a flowchart for describing the details of the prediction processing in step S13 in FIG. 7.

The processing of steps S41 through S51 and steps S52 through S61 in FIG. 9 are performed in parallel, for example.

In step S41 in FIG. 9, the intra prediction unit 24 decides a yet undecided one of 4×4 pixels, 8×8 pixels, 16×16 pixels, 32×32 pixels, and 64×64 pixels, as the PU size. Also, the intra prediction unit 24 decides, of the PUs of which the size has been decided, that make up the CU for prediction processing, a PU which has not yet been taken as an object of intra prediction processing, as the object of intra prediction processing.

In step S42, the MostProbableMode generating unit 51 reads out the peripheral optimal, intra prediction mode corresponding to the PU for intra prediction processing, from the mode buffer 46, and generates the MostProbableMode by the above-described Expression (1) based on the this peripheral optimal intra prediction mode. The MostProbableMode generating unit 51 then supplies the MostProbableMode to the difference mode generating unit 52. Also, the candidate prediction image generating unit 41 takes all candidate intra prediction modes, in order, as the current intra prediction mode, with the subsequent processing of steps S43 through S45 being performed for each current prediction mode. Note that the current intra prediction mode is supplied from the cost function value calculating unit 42 to the difference mode generating unit 52.

In step S43, the difference mode generating unit 52 generates difference intra prediction mode information, using the MostProbableMode supplied from the MostProbableMode generating unit 51 and the current intra prediction mode supplied from the cost function value calculating unit 42, and supplies this to the cost function value calculating unit 42.

In step S44, the candidate prediction image generating unit 41 performs intra prediction processing in the current, intra prediction mode on the PU for intra prediction processing, using the reference image read out from the frame memory 22 in FIG. 1 via the switch 23. The candidate prediction image generating unit 41 supplies the prediction image obtained as a result thereof to the cost function value calculating unit 42.

In step S45, the cost function value calculating unit 42 calculates the cost function value by the above-described Expression (2) or (3), based on the prediction image supplied from the candidate prediction image generating unit 41 and the image supplied from the screen rearranging buffer 12. The cost function value calculating unit 42 then supplies the obtained cost function value and the difference intra prediction mode information supplied from the difference mode generating unit 52 to the prediction mode determining unit 43. Accordingly, the prediction mode determining unit 43 stores the cost function value supplied from the cost function value calculating unit 42 and the difference intra prediction mode information, in a manner correlated with the current intra prediction mode.

In step S46, the prediction mode determining unit 43 determines the intra prediction mode corresponding to the smallest cost function value stored, correlated to all candidate intra prediction modes, for the PU for intra prediction processing, as the optimal intra prediction mode. The prediction mode determining unit 43 supplies the optimal intra prediction mode to the prediction image generating unit 44. The prediction image generating unit 44 then supplies the optimal intra prediction mode to the mode buffer 46 so as to be stored. This optimal intra prediction mode is used for deciding the MostProbableMode.

In step S47, the intra prediction unit 24 determines, whether all of the PUs of which the size has been decided in step S41, that make up the CU for prediction processing, have been taken as an object of intra prediction processing.

In the event that determination is made in step S47 that not all of the PUs of which the size has been decided in step S41, that make up the CU for prediction processing, have been taken as an object of intra prediction processing, the intra prediction unit 24 takes a PU, which has not yet been taken as the object for intra prediction processing, as the object for intra prediction processing. The flow then returns to step S42, and the subsequent processing is repeated.

On the other hand, in the event that determination is made in step S47 that, all of the PUs of which the size has been decided in step S41, that make up the CU for prediction processing, have been taken as an object of intra prediction processing, the flow advances to step S48.

In step S4 8, the intra prediction unit 24 determines whether or not all candidate PU sizes, i.e., 4×4 pixels, 8×8 pixels, 16×16 pixels, 32×32 pixels, and 64×64 pixels, have been decided for the size of the PU for intra prediction processing in step S41.

In the event that determination is made in step S48 that, not all candidate PU sizes have been decided for the size of the PU for intra prediction processing, the flow returns to step S41, and the processing of steps S41 through S48 is repeated until all candidate PU sizes have been decided for the size of the PU for intra prediction processing.

On the other hand, in the event that, determination is made in step S48 that all candidate PU sizes have been decided for the size of the PU for intra prediction processing, the flow advances to step S49. In step S49, the prediction mode determining unit 43 determines the optimal PU size for the PU size where the cost, function value is the smallest, based on the cost function value corresponding to the optimal intra prediction mode decided for all PU sizes in step S46. The prediction mode determining unit 43 supplies the optimal intra prediction mode of the optimal PU size, the corresponding optimal difference intra prediction mode information, and the cost function value, to the prediction image generating unit 44. Note that the optimal PU size is subjected to lossless encoding, for example, and included in the header information.

In step S50, the prediction image generating unit 44 performs intra prediction processing in the optimal intra prediction mode of the optimal PU size supplied from the prediction mode determining unit 43, on each PU of the optimal PU size making up the CU for prediction processing, using a reference image.

In step S51, the prediction image generating unit 44 outputs the prediction image obtained as a result of the intra prediction processing in step S50, and the cost function value supplied from the prediction mode determining unit 43, to the prediction image selecting unit 27. The prediction image generating unit 44 also supplies the optimal difference intra prediction mode information supplied from the prediction mode determining unit 43 to the intra skip determining unit 45.

Also, in step S52, the motion prediction/compensation unit 26 decides a yet undecided one of all candidate PU sizes as the PU size. Also, the motion prediction/compensation unit 26 decides, of the PUs of which the size has been decided, that make up the CU for prediction processing, a PU which has not yet been taken as an object of intra prediction processing, as the object of inter prediction processing.

In step S53, the motion prediction/compensation unit. 26 detects motion vectors of all candidate inter prediction modes, based on the image supplied from the screen rearranging buffer 62 and the reference image read out from the frame memory 22 via the switch 23. Specifically, the motion prediction/compensation unit 26 decides a reference image in accordance with the inter prediction mode. The motion prediction/compensation unit 26 then detects the motion vector based on that reference image and the image from the screen rearranging buffer 62.

In step S54, the motion prediction/compensation unit 26 subjects the reference image to compensation processing with regard to the PU for inter prediction processing, for each candidate inter prediction mode, based on the motion vectors detected in step S53, and generates a prediction image.

In step S55, the motion prediction/compensation unit 26 calculates the cost function value by the above-described Expression (2) or (3), based on the prediction image generated in step S54 and the image supplied from the screen rearranging buffer 12, for each candidate inter prediction mode.

In step S56, the motion prediction/compensation unit. 26 determines the inter prediction mode corresponding to the smallest cost function value of all candidate intra prediction modes, for the PU for intra prediction processing, as the optimal inter prediction mode.

In step S57, the motion prediction/compensation unit 26 determines whether all of the PUs of which the size has been decided in step S52, that make up the CU for prediction processing, have been taken as an object of inter prediction processing.

In the event that determination is made in step S57 that, not all of the PUs of which the size has been decided in step S52, that make up the CU for prediction processing, have been taken as an object of inter prediction processing, the motion prediction/compensation unit 26 takes a PU, which has not yet been taken as the object for inter prediction processing, as the object for inter prediction processing. The flow then returns to step S53, and the subsequent processing is repeated.

On the other hand, in the event that determination is made in step S57 that all of the PUs of which the size has been decided in step S52, that make up the CU for prediction processing, have been taken as an object, of inter prediction processing, the flow advances to step S58.

In step S58, the motion prediction/compensation unit 26 determines whether or not all candidate PU sizes have been decided for the size of the PU for intra prediction processing in step S52.

In the event that, determination is made in step S58 that not all candidate PU sizes have been decided for the size of the PU for inter prediction processing, the flow returns to step S52, and the processing of steps S52 through S58 is repeated until all candidate PU sizes have been decided for the size of the PU for inter prediction processing.

On the other hand, in the event, that determination is made in step S58 that all candidate PU sizes have been decided for the size of the PU for inter prediction processing, the flow advances to step S59. In step S59, the motion prediction/compensation unit 26 determines the optimal PU size for the PU size where the cost function value is the smallest, based on the cost function value corresponding to the optimal intra prediction mode decided for all PU sizes in step S56. Note that the optimal PU size is subjected to lossless encoding, for example, and included in the header information.

In step S60, the motion prediction/compensation unit 26 performs inter prediction processing in the optimal inter prediction mode of the optimal PU size.

In step S61, the motion prediction/compensation unit 26 outputs the prediction image obtained as a result of the inter prediction processing, and the cost, function value of the optimal intra prediction mode of the optimal PU size, to the prediction image selecting unit 27.

As described above, the encoding device 10 outputs optimal difference intra prediction mode information as information indicating the optimal intra prediction mode, so the information amount of information indicating the optimal intra prediction mode can be reduced. As a result, the encoding efficiency in the case of performing intra prediction can be improved.

Also, in the event that the MostProbableMode and the optimal intra prediction mode of the PU for intra prediction processing match, the encoding device 10 stops output of the optimal difference intra prediction mode information, so encoding efficiency can be further improved. Further, in the event that the MostProbableMode and the optimal intra prediction mode of the PU for intra prediction processing match, and the coefficient after orthogonal transform corresponding to that PU is 0, the encoding device 10 stops output of optimal difference intra prediction mode information and coefficients, so encoding efficiency can be further improved.

### [Configuration Example of Decoding Device]

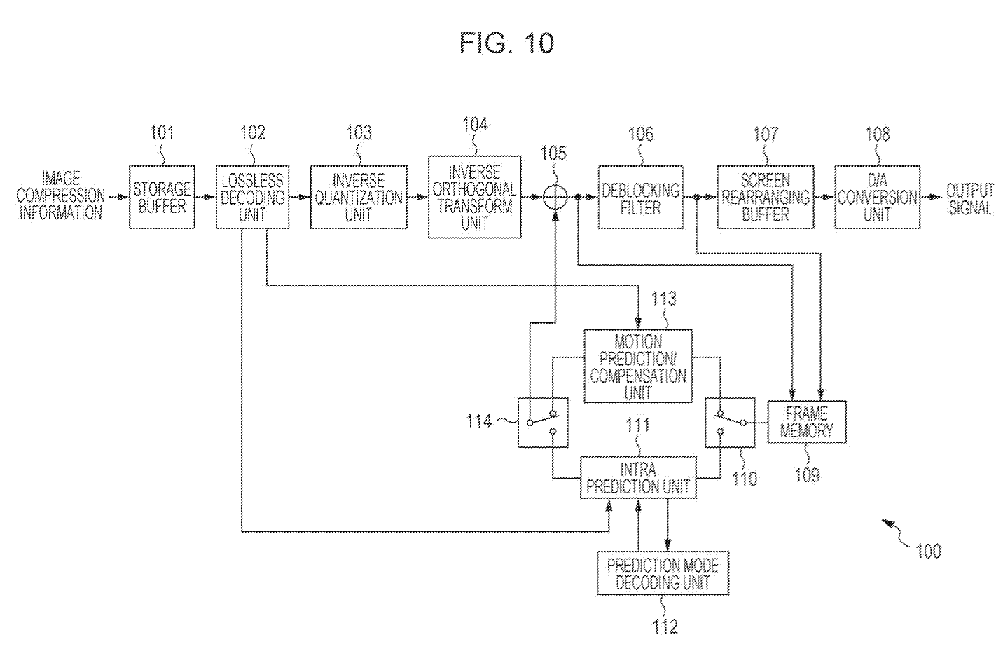

FIG. 10 is a block diagram illustrating a configuration example of a decoding device to which the present technology has been applied, which decodes image compression information output from the encoding device 10 in FIG. 1.

The decoding device 100 in FIG. 10 is configured of a storage buffer 101, a lossless decoding unit 102, an inverse quantization unit 103, an inverse orthogonal transform unit 104, an adding unit 10 5, a deblocking filter 106, a screen arranging buffer 107, a D/A conversion unit 108, frame memory 109, a switch 110, an intra prediction unit 111, a prediction mode decoding unit 112, a motion prediction/compensation unit 113, and a switch 114.

The storage buffer 101 of the decoding device 100 functions as a receiving unit, and receives (receives) and stores image compression information transmitted from the encoding device 10 in FIG. 1. The storage buffer 101 supplies the stored image compression information to the lossless decoding unit 102.

The lossless decoding unit 102 obtains a quantized coefficient and header by subjecting the image compression information from the storage buffer 101 to lossless decoding such as variable length decoding or arithmetic decoding. The lossless decoding unit 102 supplies the quantized coefficient to the inverse quantization unit 103. The lossless decoding unit 102 also supplies optimal difference intra prediction mode information and the like included in the header to the intra prediction unit 111, and supplies motion vectors, information for identifying a reference image, inter prediction mode information, and so forth, to the motion prediction/compensation unit 113.

The inverse quantization unit 103, inverse orthogonal transform unit 104, adding unit 105, deblocking filter 106, frame memory 109, switch 110, intra prediction unit 111, and motion prediction/compensation unit 113 each perform similar processing as with the inverse quantization unit 18, inverse orthogonal transform unit 19, adding unit 20, deblocking filter 21, frame memory 22, switch 23, intra prediction unit 24, and motion prediction/compensation unit 26 in FIG. 1, thereby images are decoded.

Specifically, the inverse quantization unit 103 performs inverse quantization of a quantized coefficient from the lossless decoding unit 102, and supplies a coefficient as a result thereof to the inverse orthogonal transform, unit 104.

The inverse orthogonal transform unit 104 subjects the coefficient from the inverse quantization unit 103 to inverse orthogonal transform such as IDCT, inverse KLT, or the like, and supplies the residual information obtained, as a result thereof to the adding unit 105.

The adding unit 105 adds the residual information serving as an image to be decoded that is supplied from the inverse orthogonal transform unit 104 and a prediction image supplied from the switch 114, thereby decoding the image to be decoded. The adding unit 105 supplies the image obtained as a result thereof to the deblocking filter 106, and also supplies to the frame memory 109. Note that in the event that no prediction image is supplied from the switch 114, the adding unit 105 supplies the image which is the residual information supplied from the inverse orthogonal transform unit 104 to the deblocking filter 106, and also supplies to the frame memory 109 so as to be stored.

The deblocking filter 106 performs filtering of the image supplied from the adding unit 105, thereby removing block noise. The deblocking filter 106 supplies the image obtained as a result, thereof to the frame memory 109, so as to be stored, and also supplies to the screen arranging buffer 107. The image stored in the frame memory 109 is read out via the switch 110 as a reference image, and is supplied to the motion prediction/compensation unit 113 or intra prediction unit 111.

The screen arranging buffer 107 stores images supplied from the deblocking filter 106 in increments of frames. The screen arranging buffer 107 rearranges the stored images in frame increments in order for encoding into the original order for display, and supplies to the D/A conversion unit 108.

The D/A conversion unit 108 performs D/A conversion of the images in frame increments supplied from the screen arranging buffer 107, and outputs as output signals.

The intra prediction unit 111 supplies the optimal difference intra prediction mode information supplied from the lossless decoding unit 102 to the prediction mode decoding unit 112. Also, the intra prediction unit 111 performs intra prediction processing in the optimal intra prediction mode supplied from the prediction mode decoding unit 112, using the reference image read out from the frame memory 109 via the switch 110, and generates a prediction image. The intra prediction unit 111 supplies the prediction image to the adding unit 105 via the switch 114. Further, the intra prediction unit 111 holds the optimal intra prediction mode supplied from the prediction mode decoding unit 112.

The prediction mode decoding unit 112 reads out, of the optimal, intra prediction modes held in the intra prediction unit 111, a peripheral optimal, intra prediction mode. Also, the prediction mode decoding unit 112 generates an optimal intra prediction mode for intra prediction processing, based on the optimal difference intra prediction mode information supplied from the intra prediction unit 111 and the peripheral optimal intra prediction mode that has been read out. The prediction mode decoding unit 112 supplies the generated optimal intra prediction mode to the intra prediction unit 111.

The motion prediction/compensation unit 113 reads out a reference image from the frame memory 109 via the switch 110, based on information for identifying a reference image that is supplied from the lossless decoding unit 102. The motion prediction/compensation unit 113 uses motion vectors and the reference image to perform intra prediction processing of the intra prediction mode which the intra prediction mode information indicates. The motion prediction/compensation unit 113 supplies a prediction image generated as a result, thereof to the adding unit 105 via the switch 114.

### [Configuration Example of Intra Prediction Unit and Prediction Mode Decoding Unit]

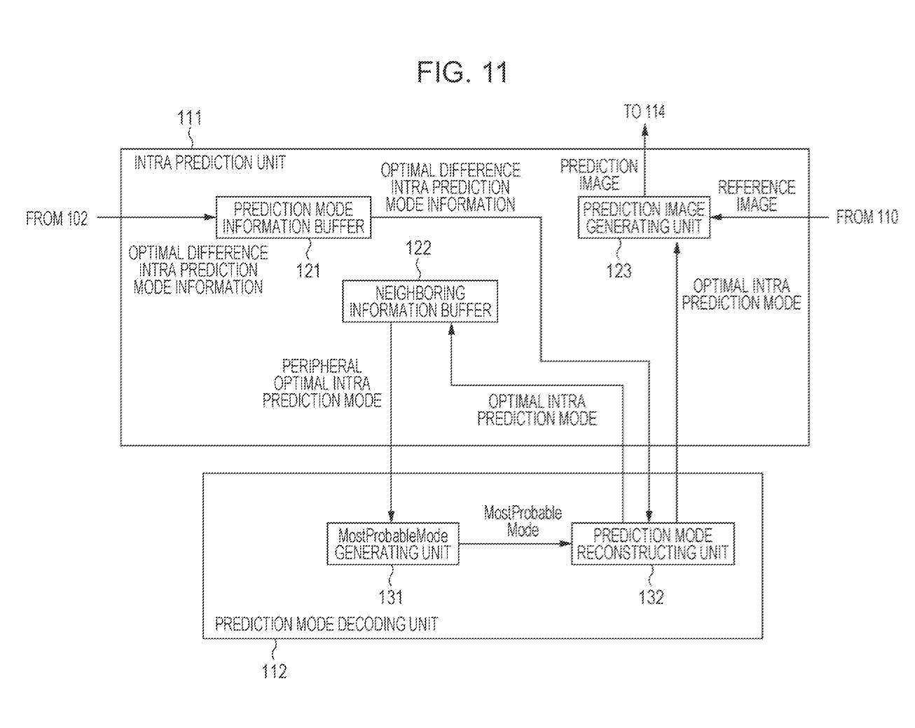

FIG. 11 is a block diagram, illustrating a configuration example of the intra prediction unit 111 and prediction mode decoding unit 112 in FIG. 10.

As illustrated in FIG. 11, the intra prediction unit 111 is configured of a prediction mode information buffer 121, a neighboring information buffer 122, and a prediction image generating unit 123.

The prediction mode information buffer 121 of the intra prediction unit 111 holds optimal difference intra prediction mode information supplied from the lossless decoding unit 102. Also, the prediction mode information buffer 121 supplies the optimal difference intra prediction mode information held therein to the prediction mode decoding unit 112.

The neighboring information buffer 122 holds the optimal intra prediction mode for the PU for intra prediction processing supplied, from the prediction mode decoding unit 112.

The prediction image generating unit 123 performs intra prediction processing in the optimal intra prediction mode supplied from the prediction mode decoding unit 112, on the PU for intra prediction processing from the image to be decoded, using the reference image supplied from the frame memory 109 via the switch 110. The prediction image generating unit 123 supplies the prediction image generated as a result of the intra prediction processing to the adding unit 105 via the switch 114 (FIG. 10).

The prediction mode decoding unit 112 is configured of a MostProbableMode generating unit 131 and a prediction mode reconstructing unit 132.

The MostProbableMode generating unit 131 of the prediction mode decoding unit 112 reads out the peripheral optimal intra prediction mode from the neighboring information buffer 122 of the intra prediction unit 111. The MostProbableMode generating unit 131 functions as a prediction value generating unit, and generates the MostProbableMode using the above-described Expression (1), using the peripheral optimal intra prediction mode that has been read out. The MostProbableMode generating unit 131 supplies the MostProbableMode to the prediction mode reconstructing unit 132 as the prediction value of the optimal intra prediction mode for the PU for intra prediction processing.

The prediction mode reconstructing unit 132 functions as an intra prediction mode generating unit. Specifically, the prediction mode reconstructing unit 132 adds the MostProbableMode supplied from the MostProbableMode generating unit 131 and the optimal difference intra prediction mode information supplied from the prediction mode information buffer 121, thereby generating an optimal intra prediction mode for the PU for intra prediction processing. The prediction mode reconstructing unit 132 supplies the generated optimal intra prediction mode to the neighboring information buffer 122 and prediction image generating unit 123 of the intra prediction unit 111.

### [Description of Processing of Decoding Device]

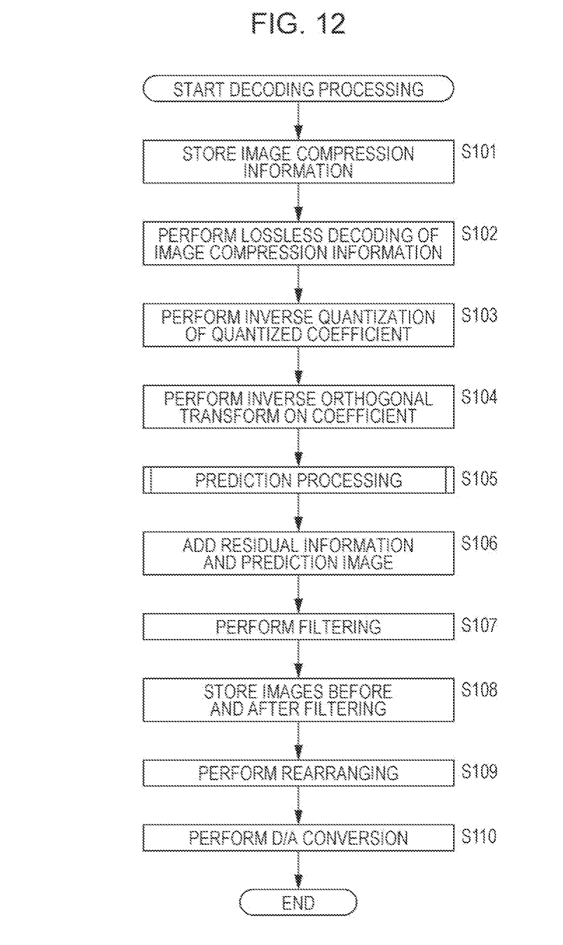

FIG. 12 is a flowchart for describing the decoding processing by the decoding device 100 in FIG. 10. This decoding processing is performed each time image compression information in frame increments is input to the decoding device 100, for example.

In step S101 in FIG. 12, the storage buffer 101 receives the image compression information in frame increments transmitted from the encoding device 10, and stores. The storage buffer 101 supplies the stored image compression information to the lossless decoding unit 102. Note that the processing of the following steps S101 through S108 is performed in CU increments, for example.

In step S102, the lossless decoding unit 102 performs lossless decoding of the image compression information from the storage buffer 101, and obtains a quantized coefficient and header. The lossless decoding unit 102 supplies the quantized coefficient to the inverse quantization unit 103.

Note that, of the PUs making up the CU to be decoded, no image compression information exists for PUs encoded in intra skip mode, so the lossless decoding unit 102 supplies the inverse quantization unit 103 with 0 as a quantized coefficient for that PU. Accordingly, the decoding results obtained in the later-described step S106 is the prediction image itself.

In step S103, the inverse quantization unit 103 performs inverse quantization of the quantized coefficient, from the lossless decoding unit 102, and supplies the coefficient obtained as a result thereof to the inverse orthogonal transform unit 104.

In step S104, the inverse orthogonal transform unit 104 subjects the coefficient from, the inverse quantization unit 103 to inverse orthogonal transform such as IDCT, inverse KLT, and so forth, and supplies the residual information obtained as a result thereof to the adding unit 105.

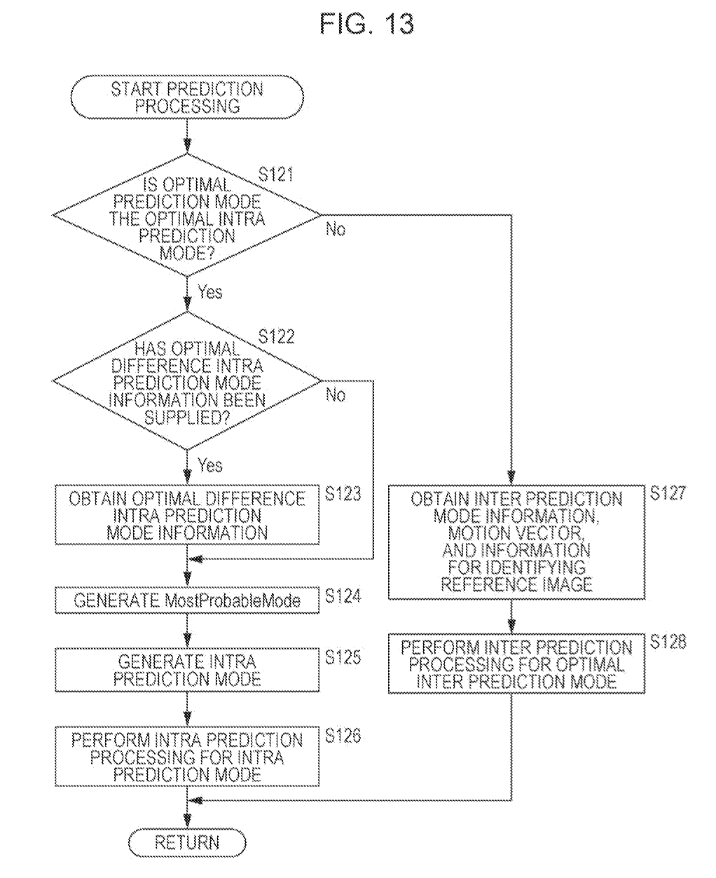

In step S105, the decoding device 100 performs prediction processing in which intra prediction processing or inter prediction processing is performed. Details of this prediction processing will be described later with reference to FIG. 13.

In step S106, the adding unit 105 adds the residual information and the prediction image supplied from, the switch 114, thereby performing decoding. The adding unit 105 supplies the image obtained as a result, thereof to the deblocking filter 106, and also supplies this to the frame memory 109. Note that in the event that no reference image exists, the processing of steps S105 and S106 is not performed, the image which is the residual information is supplied to the deblocking filter 106, and also supplied to the frame memory 109.

In step S107, the deblocking filter 106 performs filtering on the image supplied from the adding unit 105, and removes block noise. The deblocking filter 106 supplies the image following filtering to the frame memory 109.

In step S108, the frame memory 109 stores the image before filtering supplied from the adding unit 105, and the image after filtering supplied from the deblocking filter 106. The images stored in the frame memory 109 are supplied as reference images to the motion prediction/compensation unit 113 or intra prediction unit 111 via the switch 110.

In step S109, the screen arranging buffer 107 stores the image supplied from the deblocking filter 106 in frame increments, rearranges the images in frame increments stored in order for encoding into the original order for display, and supplies to the D/A conversion unit 108.

In step S110, the D/A conversion unit 108 performs D/A conversion of the images in frame increments supplied from the screen arranging buffer 107, and outputs as output signals.

FIG. 13 is a flowchart, for describing the prediction processing in step S105 in FIG. 12 in detail. Note that this prediction processing is performed in PU increments.

In step S121 in FIG. 13, the lossless decoding unit 102 determines whether or not the optimal prediction mode is the optimal intra prediction mode. Specifically, in the event that no image compression information for the PU for prediction processing exists, or no intra prediction mode information is included in the image compression information header, the lossless decoding unit 102 determines that the optimal prediction mode is the optimal intra prediction mode. On the other hand, in the event that inter prediction mode information is included in the header of the image compression information for the PU for prediction processing, determination is made that the optima prediction mode is not the optimal intra prediction mode.

In step S121, in the event that determination is made that, the optimal prediction mode is the optimal intra prediction mode, the lossless decoding unit 102 supplies the optimal difference intra prediction mode information and so forth included in the header to the intra prediction unit 111 and the switch 114.

Then, in step S122, the prediction mode information buffer 121 (FIG. 11) of the intra prediction unit 111 determines whether or not optimal difference intra prediction mode information has been supplied from the lossless decoding unit 102.

In the event, that determination is made in step S122 that, optimal difference intra prediction mode information has been supplied from the lossless decoding unit 102, in step S123 the prediction mode information buffer 121 obtains and holds this optimal difference intra prediction mode information. The prediction mode information buffer 121 supplies the held optimal difference intra prediction mode information to the prediction mode reconstructing unit 132 of the prediction mode decoding unit 112, and advances the flow to step S124.

On the other hand, in the event that determination is made in step S122 that no optimal difference intra prediction mode information has been supplied from the lossless decoding unit 102, i.e., in the event that no optimal difference intra prediction mode information is included in the header or no image compression information exists, the flow advances to step S124.

In step S124, the MostProbableMode generating unit 131 uses the peripheral optimal intra prediction mode read out from the neighboring information buffer 122 to generate the MostProbableMode as the prediction value of the optimal intra prediction mode by the above-described Expression (1). The MostProbableMode generating unit 131 then supplies the MostProbableMode to the prediction mode reconstructing unit. 132.

In step S125, the prediction mode reconstructing unit 132 adds the MostProbableMode from the MostProbableMode generating unit 131 and the optimal difference intra prediction mode information from the prediction mode information buffer 121, thereby generate the optimal intra prediction mode. Note that there is no optimal difference intra prediction mode information supplied from the prediction mode information buffer 121, the MostProbableMode is taken as the optimal intra prediction mode as it is. The prediction mode reconstructing unit 132 supplies the generated optimal intra prediction mode to the neighboring information buffer 122 so as to be held, and also supplies to the prediction image generating unit 123.

In step S126, the prediction image generating unit 123 performs intra prediction processing in the optimal intra prediction mode supplied from the prediction mode decoding unit 112, using the reference image supplied from the frame memory 109 via the switch 110. The prediction image generating unit 123 supplies the prediction image generated as a result of the intra prediction processing to the adding unit 105 via the switch 114. The processing then returns to step S105 in FIG. 12, and advances to step S106.

On the other hand, in the event that determination is made in step S121 that the optimal prediction mode is not the optimal intra prediction mode, i.e., in the event that determination is made that the optimal prediction mode is the optimal inter prediction mode, the lossless decoding unit 102 supplies motion vectors, inter prediction mode information, information for identifying the reference image, and so forth, to the motion prediction/compensation unit 113.

Then in step S127, the motion prediction/compensation unit 113 obtains the motion vectors, inter prediction mode information, information for identifying the reference image, and so forth, from the lossless decoding unit 102.

In step S128, the motion prediction/compensation unit 113 performs inter prediction processing of the optimal inter prediction mode using the reference image read out via the switch 110, based on the motion vectors, inter prediction mode information, and information for identifying the reference image. The motion prediction/compensation unit 113 supplies the prediction image generated as a result thereof to the adding unit 105 via the switch 114. The flow then returns to step S105 in FIG. 12, and advances to step S106.

As described above, the decoding device 100 receives the optimal difference intra prediction mode information from the encoding device 10, generates an optimal intra prediction mode by adding the optimal difference intra prediction mode information and the MostProbableMode, and performs intra prediction processing in the optimal intra prediction mode. As a result, the image compression information of which the encoding efficiency in the event of performing intra prediction has been improved, generated, by the encoding device 10, can be detected.

Note that while this embodiment has been arranged to use the HEVC format as a base, the present technology is not restricted to this, and can be applied to an encoding device/decoding device using an encoding format/decoding format performing intra prediction processing of multiple intra prediction modes. Note however, that in the event that the number of modes of intra prediction mode is great as with the HEVC format, the probability that the MostProbableMode and the optimal intra prediction mode for the PU for intra prediction processing will differ is great, so this is more effective.

Also, with the present embodiment, intra skip mode has been set in PU increments, but intra skip mode may be set in CU increments or frame increments.

Also, the present technology is applicable to an encoding device and decoding device used for receiving image information (bit stream) compressed with a format compressing with orthogonal transform such as discrete cosine transform or the like and motion compensation, as with MPEG, H.26x, and the like, for example, via satellite broadcasting, cable television, the Internet, cellular phones, and other like network media. Also, the present technology can be applied to an encoding device and encoding device used in the event of performing processing on storage media such as optical discs, magnetic disks, flash memory, and so forth. Further, the present technology can also be applied to an intra prediction device included in these encoding device and decoding device and so forth.

[Description of Computer to Which Present Technology has been Applied]

The above-described encoding processing and decoding processing may be executed by hardware, or may be executed by software. In the event of executing the encoding processing or decoding processing by software, a program making up the software thereof is installed in a general-purpose computer or the like.

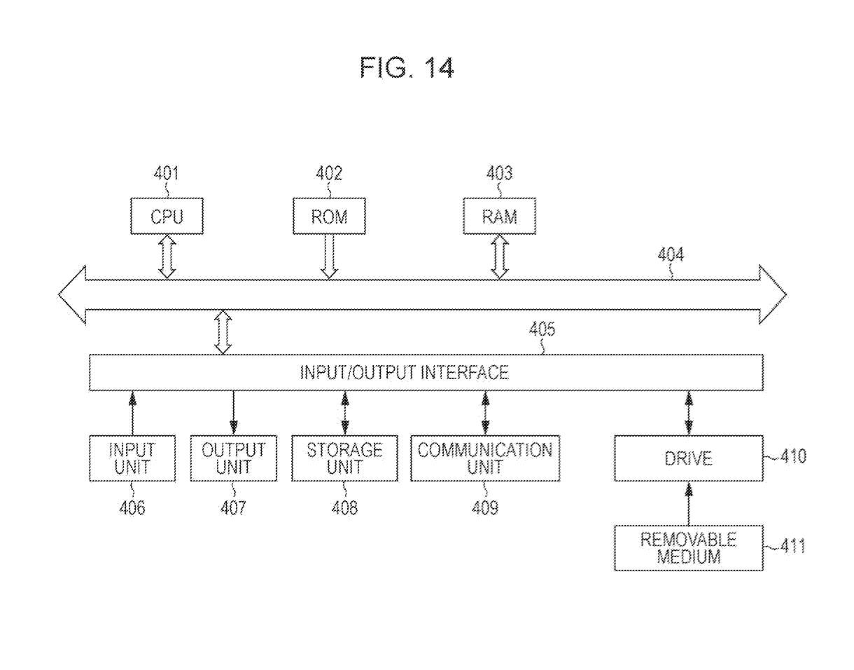

FIG. 14 illustrates a configuration example of an embodiment of a computer into which is installed a program which executes the above-described series of processing.

The program may be recorded beforehand in a recording unit 408 or ROM (Read Only Memory) 402 serving as a recording medium built into the computer.

Alternatively, the program, may be stored (recorded) in removable media 411. Such removable media 411 can be provided as so-called package software. Examples of the removable media 411 include flexible disks, CD-ROM (Compact Disc Read Only Memory), MO (Magneto Optical) discs, DVD (Digital Versatile Disc), magnetic disks, semiconductor memory and so forth.

Note that the program, may be, besides being installed to the computer from the removable media. 411 such as described above via the drive 410, downloaded to the computer via communication network or broadcasting network, and installed to the storage unit 408 built in. That is to say, the program may be wirelessly transmitted to the computer from a download site via digital broadcasting satellite, or transmitted to the computer by cable via a network such as a LAN (Local. Area Network), the Internet, or the like.

The computer has built in a CPU (Central Processing Unit) 401, with an input/output interface 405 connected to the CPU 401 via a bus 404.

Upon an instruction being input via the input/output interface 405 by the user operating an input unit 406 or the like, a program stored in the ROM 402 is executed accordingly. Alternatively, the CPU 401 loads a program stored in the storage unit 408 to RAM (Random Access Memory) 403 to be executed.

Thus, the CPU 401 performs processing following the above-described flowcharts, or processing preformed by the configurations in the above-described block diagrams. The CPU 401 outputs the processing results thereof as necessary, from an output unit 407 via the input/output interface 405 for example, or transmits from a communication unit 409 or records in the storage unit 408 or the like.

The input unit 406 is made up of a keyboard, a mouse, a microphone, and so forth. The output unit 407 is made up of an LCD (Liquid Crystal Display), a speaker, and so forth.

Note that with the present specification, the processing that the computer executes following the program does not have to be performed in the time sequence along the sequence described in the flowcharts. That is to say, the processing that the computer executes includes processing performed in parallel or individually (e.g., parallel processing or object-oriented processing).

Also, the program may be processed by a single computer (processor) or may be processed in a distributed manner among multiple computers. Further, the program may be transferred to a remote computer so as to be executed.

### [Configuration Example of Television Receiver]

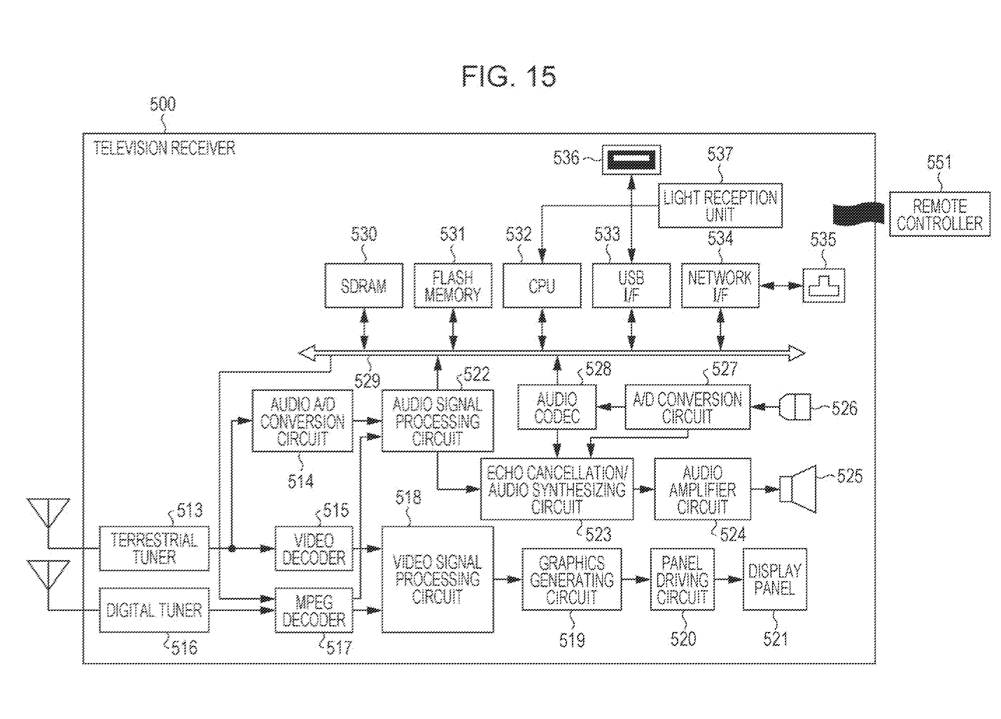

FIG. 15 is a block diagram illustrating a principal configuration example of a television receiver using a decoding device to which the present technology has been applied.

A television receiver 500 shown in FIG. 15 includes a terrestrial tuner 513, a video decoder 515, a video signal processing circuit 518, a graphics generating circuit 519, a panel driving circuit 520, and a display panel 521.

The terrestrial tuner 513 receives the broadcast wave signals of a terrestrial analog broadcast via an antenna, demodulates, obtains video signals, and supplies these to the video decoder 515. The video decoder 515 subjects the video signals supplied from the terrestrial tuner 513 to decoding processing, and supplies the obtained digital component signals to the video signal processing circuit 518.

The video signal processing circuit. 518 subjects the video data supplied from the video decoder 515 to predetermined processing such as noise removal or the like, and supplies the obtained video data to the graphics generating circuit 519.

The graphics generating circuit 519 generates the video data of a program to be displayed on a display panel 521, or image data due to processing based, on an application to be supplied via a network, or the like, and supplies the generated video data or image data to the panel driving circuit 520. Also, the graphics generating circuit 519 also performs processing such as supplying video data obtained by generating video data (graphics) for the user displaying a screen used for selection of an item or the like, and superimposing this on the video data of a program, to the panel, driving circuit 520 as appropriate.

The panel driving circuit 520 drives the display panel 521 based on the data supplied from the graphics generating circuit 519 to display the video of a program, or the above-described various screens on the display panel 521,

The display panel 521 is made up of an LCD (Liquid Crystal Display) and so forth, and displays the video of a program or the like in accordance with the control by the pane 1 driving circuit 520.

Also, the television receiver 50 0 also includes an audio A/D (Analog/Digital) conversion circuit 514, an audio signal processing circuit 522, an echo cancellation/audio synthesizing circuit 523, an audio amplifier circuit 524, and a speaker 525.

The terrestrial tuner 513 demodulates the received broadcast wave signal, thereby obtaining not only a video signal but also an audio signal. The terrestrial tuner 513 supplies the obtained audio signal to the audio A/D conversion circuit 514.

The audio A/D conversion circuit 514 subjects the audio signal supplied from the terrestrial tuner 513 to A/D conversion processing, and supplies the obtained digital audio signal to the audio signal processing circuit 522.

The audio signal processing circuit 522 subjects the audio data supplied from the audio A/D conversion circuit 514 to predetermined processing such as noise removal or the like, and supplies the obtained audio data to the echo cancellation/audio synthesizing circuit 523.

The echo cancellation/audio synthesizing circuit 523 supplies the audio data supplied from the audio signal processing circuit 522 to the audio amplifier circuit 524.

The audio amplifier circuit 524 subjects the audio data supplied from the echo cancellation/audio synthesizing circuit 523 to D/A conversion processing, subjects to amplifier processing to adjust to predetermined volume, and then outputs the audio from the speaker 525.

Further, the television receiver 500 also includes a digital tuner 516, and an MPEG decoder 517.

The digital tuner 516 receives the broadcast wave signals of a digital broadcast (terrestrial digital broadcast, BS (Broadcasting Satellite)/CS (Communications Satellite) digital broadcast) via the antenna, demodulates to obtain MPEG-TS (Moving Picture Experts Group-Transport Stream), and supplies this to the MPEG decoder 517.

The MPEG decoder 517 descrambles the scrambling given to the MPEG-TS supplied from the digital tuner 516, and extracts a stream including the data of a program serving as a playing object (viewing object). The MPEG decoder 517 decodes an audio packet, making up the extracted stream, supplies the obtained audio data to the audio signal processing circuit 522, and also decodes a video packet, making up the stream, and supplies the obtained video data to the video signal processing circuit 518. Also, the MPEG decoder 517 supplies EPG (Electronic Program Guide) data extracted from the MPEG-TS to a CPU 532 via an unshown path.

The television receiver 500 uses the above-described decoding device 100 as the MPEG decoder 517 for decoding video packets in this way. Accordingly, the MPEG decoder 517 can decode images encoded so as to achieve higher encoding efficiency, in the same way as with the case of the above-described decoding device 100.

The video data supplied from the MPEG decoder 517 is, in the same way as with the case of the video data supplied from the video decoder 515, subjected to predetermined processing at the video signal processing circuit 518. The video data subjected to predetermined processing is then superimposed on the generated video data and so forth at the graphics generating circuit 519 as appropriate, supplied to the display panel 521 via the panel driving circuit 520, and the image thereof is displayed thereon.

The audio data supplied from the MPEG decoder 517 is, in the same: way as with the case of the audio data supplied from the audio A/D conversion circuit 514, subjected to predetermined processing at the audio signal processing circuit 522, supplied to the audio amplifier circuit 524 via the echo cancellation/audio synthesizing circuit 523, and subjected to D/A conversion processing and amplifier processing. As a result thereof, the audio adjusted in predetermined volume is output from the speaker 525.

Also, the television receiver 500 also includes a microphone 526, and an A/D conversion circuit 527.

The A/D conversion circuit 527 receives the user's audio signals collected by the microphone 526 provided, to the television receiver 500 serving as for audio conversation, subjects the received audio signal to A/D conversion processing, and supplies the obtained digital audio data to the echo cancellation/audio synthesizing circuit 523.

In the event that the user (user A)'s audio data of the television receiver 500 has been supplied from the A/D conversion circuit 527, the echo cancellation/audio synthesizing circuit 523 performs echo cancellation on the user (user A)'s audio data, and outputs audio data obtained by synthesizing with other audio data, or the like from the speaker 525 via the audio amplifier circuit 524.

Further, the television receiver 500 also includes an audio codec 528, an internal bus 529, SDRAM (Synchronous Dynamic Random Access Memory) 530, flash memory 531, a CPU 532, a USB (Universal Serial Bus) I/F 533, and a network I/F 534.

The A/D conversion circuit 527 receives the user's audio signal collected by the microphone 52 6 provided to the television receiver 500 serving as for audio conversation, subjects the received audio signal to A/D conversion processing, and supplies the obtained, digital audio data to the audio codec 528.

The audio codec 528 converts the audio data supplied from the A/D conversion circuit 527 into the data of a predetermined format for transmission via a network, and supplies to the network I/F 534 via the internal bus 529.

The network I/F 534 is connected to the network via a cable mounted on a network terminal 535. The network I/F 534 transmits the audio data supplied from the audio codec 528 to another device connected to the network thereof, for example. Also, the network I/F 534 receives, via the network terminal 535, the audio data transmitted from another device connected thereto via the network, and supplies this to the audio codec 528 via the internal bus 529, for example.

The audio codec 528 converts the audio data supplied from the network I/F 534 into the data of a predetermined format, and supplies this to the echo cancellation/audio synthesizing circuit. 523.

The echo cancellation/audio synthesizing circuit 523 performs echo cancellation with the audio data supplied from the audio codec 528 taken as a object, and outputs the data of audio obtained by synthesizing the audio data and other audio data, or the like, from the speaker 525 via the audio amplifier circuit 524.

The SDRAM 530 stores various types of data necessary for the CPU 532 performing processing.

The flash memory 5 31 stores a program to be executed by the CPU 532. The program stored in the flash memory 531 is read out by the CPU 5 32 at predetermined timing such as when activating the television receiver 500, or the like. EPG data obtained via a digital broadcast, data obtained, from a predetermined server via the network, and so forth are also stored in the flash memory 531.

For example, MPEG-TS including the content data obtained from a predetermined server via the network by the control of the CPU 532 is stored in the flash memory 531. The flash memory 531 supplies the MPEG-TS thereof to the MPEG decoder 517 via the internal bus 529 by the control of the CPU 532, for example.

The MPEG decoder 517 processes the MPEG-TS thereof in the same way as with the case of the MPEG-TS supplied from the digital tuner 516. In this way, the television receiver 500 receives the content data made up of video, audio, and so forth via the network, decodes using the MPEG decoder 517, whereby video thereof can be displayed, and audio thereof can be output.

Also, the television receiver 500 also includes a light reception unit 537 for receiving the infrared signal transmitted from a remote controller 551.

The light reception unit 537 receives infrared rays from the remote controller 551, and outputs a control code representing the content of the user's operation obtained by demodulation, to the CPU 532.

The CPU 532 executes the program stored in the flash memory 531 to control the entire operation of the television receiver 500 according to the control code supplied from the light reception unit 537, and so forth. The CPU 532, and the units of the television receiver 500 are connected via an unshown path.

The USB I/F 533 performs transmission/reception of data as to an external device of the television receiver 500 which is connected via a USB cable mounted on a USB terminal 536. The network I/F 534 connects to the network via a cable mounted on the network terminal 535, also performs transmission/reception of data other than audio data as to various devices connected to the network.

The television receiver 500 can decode images encoded so as to improve encoding efficiency in a case of performing intra prediction, by using the decoding device 100 as the MPEG decoder 517.

### [Configuration Example of Cellular Telephone]

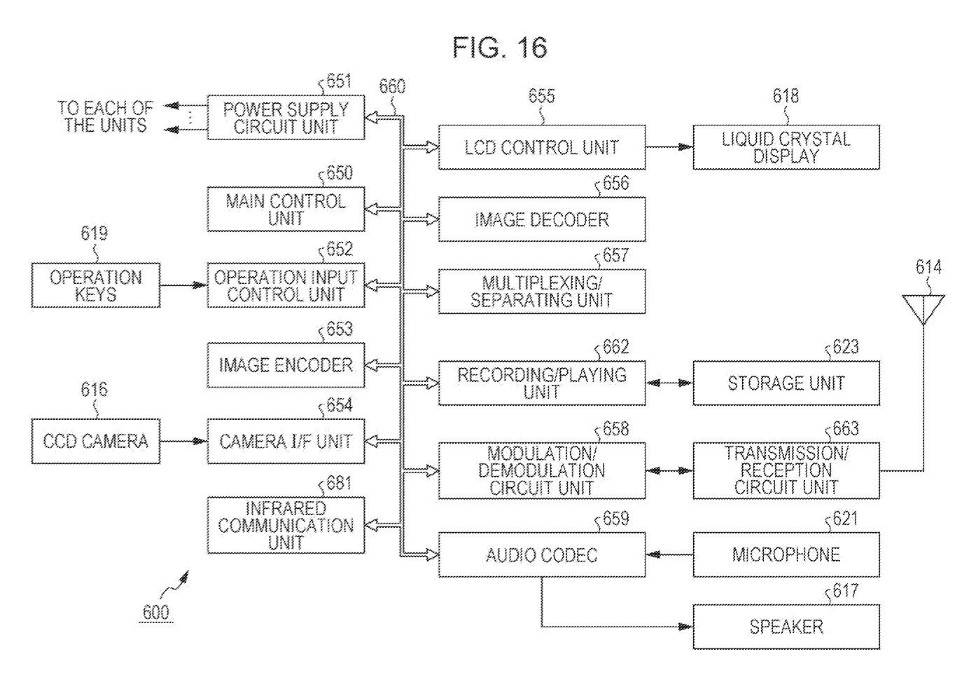

FIG. 16 is a block diagram, illustrating a principal configuration example of a cellular telephone using the encoding device and decoding device to which the present technology has been applied.

A cellular telephone 600 shown in FIG. 16 includes a main control unit 650 configured so as to integrally control the units, a power supply circuit unit 651, an operation input control unit 652, an image encoder 653, a camera I/F unit 654, an LCD control unit 655, an image decoder 656, a multiplexing/separating unit 657, a recording/playing unit 662, a modulation/demodulation circuit unit 658, and an audio codec 659. These are mutually connected via a bus 660.

Also, the cellular telephone 600 includes operation keys 619, a CCD (Charge Coupled Devices) camera 616, a liquid crystal display 618, a storage unit 623, a transmission/reception circuit unit 663, an antenna 614, a microphone (MIC) 621, and a speaker 617.

Upon a call end and power key being turned on by the user's operation, the power supply circuit unit 651 activates the cellular telephone 600 in an operational state by supplying power to the units from a battery pack.

The cellular telephone 600 performs various operations, such as transmission/reception of an audio signal, transmission/reception of an e-mail and image data, image shooting, data recoding, and so forth, in various modes such as a voice call mode, a data communication mode, and so forth, based on the control of the main control unit 650 made up of a CPU, ROM, RAM, and so forth.

For example, in the voice call mode, the cellular telephone 600 converts the audio signal collected by the microphone (mike) 621 into digital audio data by the audio codec 659, subjects this to spectrum spread processing at the modulation/demodulation circuit unit 658, and subjects this to digital/analog conversion processing and frequency conversion processing at the transmission/reception circuit, unit 663. The cellular telephone 600 transmits the signal for transmission obtained by the conversion processing thereof to an unshown base station via the antenna 614. The signal for transmission (audio signal) transmitted to the base station is supplied to the cellular telephone of the other party via the public telephone network.

Also, for example, in the voice call mode, the cellular telephone 600 amplifies the reception signal received at the antenna 614, at the transmission/reception circuit unit 663, further subjects to frequency conversion processing and analog/digital conversion processing, subjects to spectrum inverse spread processing at the modulation/demodulation circuit unit 658, and converts into an analog audio signal by the audio codec 659. The cellular telephone 600 outputs the converted and obtained analog audio signal thereof from the speaker 617.

Further, for example, in the event, of transmitting an e-mail in the data communication mode, the cellular telephone 600 accepts the text data of the e-mail input by the operation of the operation keys 619 at the operation input control unit 652. The cellular telephone 600 processes the text data thereof at the main control unit 650, and displays on the liquid crystal display 618 via the LCD control unit 655 as an image.

Also, the cellular telephone 600 generates e-mail data at the main control unit 650 based on the text data accepted by the operation input control unit 652, the user's instructions, and so forth. The cellular telephone 600 subjects the e-mail data thereof to spectrum spread processing at the modulation/demodulation circuit unit 658, and subjects to digital/analog conversion processing and frequency conversion processing at the transmission/reception circuit unit 663. The cellular telephone 600 transmits the signal for transmission obtained by the conversion processing thereof to an unshown base station via the antenna 614. The signal for transmission (e-mail) transmitted to the base station is supplied to a predetermined destination via the network, mail server, and so forth.

Also, for example, in the event of receiving an e-mail in the data communication mode, the cellular telephone 600 receives the signal transmitted from the base station via the antenna 614 with the transmission/reception circuit unit 663, amplifies, and further subjects to frequency conversion processing and analog/digital conversion processing. The cellular telephone 600 subjects the reception signal thereof to spectrum inverse spread processing at the modulation/demodulation circuit unit 658 to restore the original e-mail data. The cellular telephone 600 displays the restored e-mail data on the liquid crystal display 618 via the LCD control unit 655.

Note that the cellular telephone 600 may record (store) the received e-mail data in the storage unit 623 via the recording/playing unit 662.

This storage unit 623 is an optional rewritable recording medium. The storage unit 623 may be semiconductor memory such as RAM, built-in flash memory, or the like, may be a hard disk, or may be a removable medium, such as a magnetic disk, a magneto-optical disk, an optical disc, USB memory, a memory card, or the like. It goes without saying that the storage unit 623 may be other than these.

Further, for example, in the event, of transmitting image data in the data communication mode, the cellular telephone 600 generates image data by imaging at the CCD camera 616. The CCD camera 616 includes a CCD serving as an optical device such as a lens, diaphragm, and so forth, and serving as a photoelectric conversion device, which images a subject, converts the intensity of received light into an electrical signal, and generates the image data of an image of the subject. The CCD camera 616 performs compression encoding of the image data at the image encoder 653 via the camera I/F unit 654 for example, by predetermined encoding format such as MPEG2, MPEG4, and so forth, and converts into encoded image data.

The cellular telephone 600 employs the above-described encoding device 10 as the image encoder 653 for performing such processing. Accordingly, in the same way as with the above-described encoding device 10, the image encoder 653 can achieve higher encoding efficiency in a case of performing intra prediction.

Note that, at this time simultaneously, the cellular telephone 600 converts the audio collected at the microphone (mike) 621, while shooting with the CCD camera 616, from analog to digital at the audio codec 659, and further encodes this.

The cellular telephone 600 multiplexes the encoded image data supplied from the image encoder 653, and the digital audio data supplied from the audio codec 659 at the multiplexing/separating unit 657 using a predetermined method. The cellular telephone 600 subjects the multiplexed, data obtained as a result thereof to spectrum spread, processing at the modulation/demodulation circuit unit 658, and subjects to digital/analog conversion processing and frequency conversion processing at the transmission/reception circuit unit 663. The cellular telephone 600 transmits the signal for transmission obtained by the conversion processing thereof to an unshown base station via the antenna 614. The signal for transmission (image data) transmitted to the base station is supplied to the other party via the network or the like.

Note that in the event that image data is not transmitted, the cellular telephone 600 may also display the image data generated at the CCD camera 616 on the liquid crystal display 618 via the LCD control unit 655 instead of the image encoder 653.

Also, for example, in the event of receiving the data of a moving image file linked to a simple website or the like in the data communication mode, the cellular telephone 600 receives the signal transmitted from the base station at the transmission/reception circuit unit 663 via the antenna 614, amplifies, and further subjects to frequency conversion processing and analog/digital conversion processing. The cellular telephone 600 subjects the received signal to spectrum inverse spread processing at the modulation/demodulation circuit unit. 658 to restore the original multiplexed data. The cellular telephone 600 separates the multiplexed data thereof at the multiplexing/separating unit 657 into encoded image data and audio data.

The cellular telephone 600 decodes the encoded image data at the image decoder 656 by a decoding format corresponding to the predetermined encoding format such as MPEG 2, MPEG 4, and so forth, thereby generating playing moving image data, and displays this on the liquid crystal display 618 via the LCD control unit 655. Thus, moving image data included in a moving image file linked to a simple website is displayed on the liquid crystal display 618, for example.

The cellular telephone 600 employs the above-described decoding device 100 as the image decoder 656 for performing such processing. Accordingly, in the same way as with the decoding device 100, the image decoder 656 can decode images encoded so as to improve encoding efficiency in a case of performing intra prediction.

At this time, simultaneously, the cellular telephone 600 converts the digital audio data into an analog audio signal at the audio codec 659, and outputs this from the speaker 617. Thus, audio data included in a moving image file linked to a simple website is played, for example.

Note that, in the same way as with the case of e-mail, the cellular telephone 600 may record (store) the received data linked to a simple website or the like in the storage unit 623 via the recording/playing unit 662.

Also, the cellular telephone 600 analyzes the imaged two-dimensional code obtained by the CCD camera 616 at the main control unit 650, whereby information recorded in the two-dimensional code can be obtained.

Further, the cellular telephone 600 can communicate with an external device at the infrared communication unit 681 using infrared rays.

The cellular telephone 600 employs the above-described encoding device 10 as the image encoder 653, whereby encoding efficiency can be improved in a case of performing intra prediction.

Also, the cellular telephone 600 employs the above-described decoding device 100 as the image decoder 656, whereby images can be decoded which have been encoded so as to improve encoding efficiency.

Note that description has been made so far wherein the cellular telephone 600 employs the CCD camera 616, but the cellular telephone 600 may employ an image sensor (CMOS image sensor) using CMOS (Complementary Metal Oxide Semiconductor) instead of this CCD camera 616. In this case as well, the cellular telephone 600 can image a subject and generate the image data of an image of the subject in the same way as with the case of employing the CCD camera 616.

Also, description has been made so far regarding the cellular telephone 600, but the encoding device 10 and decoding device 100 may be applied to any kind of device in the same way as with the case of the cellular telephone 600 as long as it is a device having the same imaging function and communication function as those of the cellular telephone 600, for example, such as a PDA (Personal Digital Assistants), smart phone, UMPC (Ultra Mobile Personal Computer), net book, notebook-sized personal computer, or the like.

[Configuration Example of Hard Disk. Recorder]

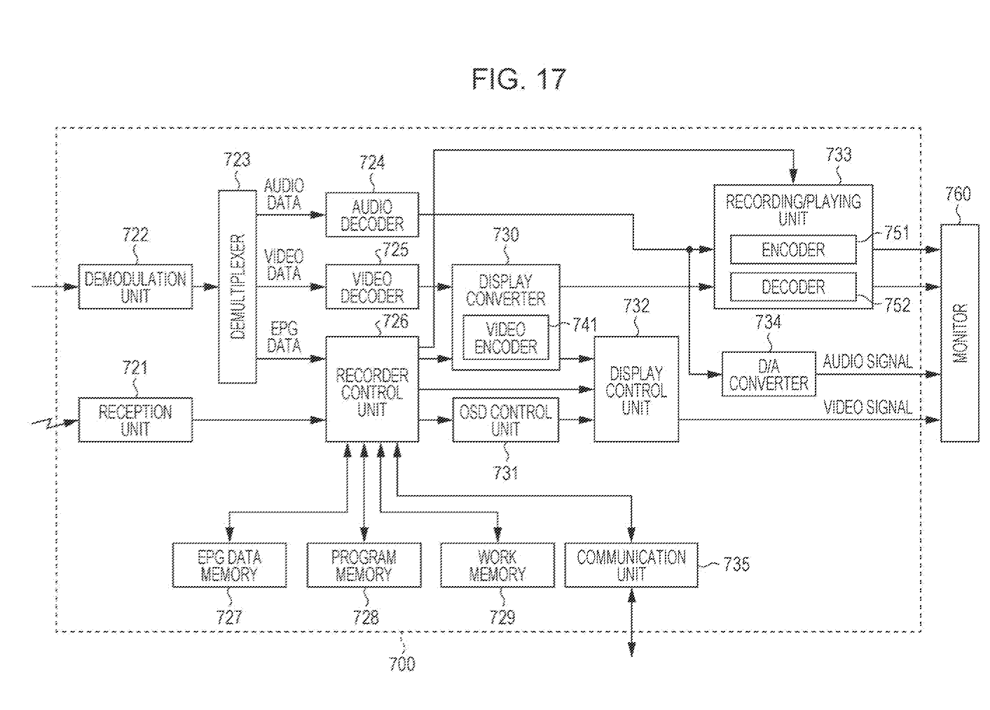

FIG. 17 is a block diagram, illustrating a principal configuration example of a hard, disk recorder which employs the encoding device and decoding device to which the present technology has been applied.

A hard disk recorder (HDD recorder) 700 shown in FIG. 17 is a device which stores, in a built-in hard disk, audio data and video data of a broadcast program included in broadcast wave signals (television signals) received by a tuner and transmitted from a satellite or a terrestrial antenna or the like, and provides the stored data to the user at timing according to the user's instructions.

The hard disk recorder 700 can extract audio data and video data from broadcast wave signals, decode these as appropriate, and store in the built-in hard disk, for example. Also, the hard disk recorder 700 can also obtain audio data and video data from another device via the network, decode these as appropriate, and store in the built-in hard disk, for example.

Further, the hard disk recorder 700 can decode audio data and video data recorded in the built-in hard disk, supply this to a monitor 760, and display an image thereof on the screen of the monitor 760, for example. The hard disk recorder 700 can also output audio thereof from the speaker of the monitor 760.

The hard disk recorder 700 can decode audio data and video data extracted from broadcast signals obtained via a tuner, or audio data and video data obtained from another device via a network, supply this to the monitor 760, and display an image thereof on the screen of the monitor 760, for example. The hard disk recorder 700 can also output audio thereof from the speaker of the monitor 760.

Of course, operations other than these may be performed.

As shown in FIG. 17, the hard disk recorder 700 includes a reception unit 721, a demodulation unit 722, a demultiplexer 723, an audio decoder 724, a video decoder 725, and a recorder control unit 726. The hard disk recorder 700 further includes EPG data memory 727, program memory 728, work memory 729, a display converter 730, an OSD (On Screen Display) control unit 731, a display control unit 732, a recording/playing unit 733, a D./A converter 734, and a communication unit 735.

Also, the display converter 730 includes a video encoder 741. The recording/playing unit 733 includes an encoder 751 and a decoder 752.

The reception unit 721 receives the infrared signal from the remote controller (not shown), converts into an electrical signal, and outputs to the recorder control unit 726. The recorder control unit 726 is configured of, for example, a microprocessor and so forth, and executes various types of processing in accordance with the program stored in the program memory 728. At this time, the recorder control unit 726 uses the work memory 729 according to need.

The communication unit 735, which is connected to the network, performs communication processing with another device via the network. For example, the communication unit 735 is controlled by the recorder control unit 726 to communicate with a tuner (not shown), and to principally output a channel selection control signal to the tuner.

The demodulation unit 722 demodulates the signal supplied from the tuner, and outputs to the demultiplexer 723. The demultiplexer 723 separates the data supplied from the demodulation unit 722 into audio data, video data, and EPG data, and outputs to the audio decoder 724, video decoder 725, and recorder control unit 726, respectively.

The audio decoder 72 4 decodes the input audio data, for example, with the MPEG format, and outputs to the recording/playing unit 733. The video decoder 725 decodes the input video data, for example, with the MPEG format, and outputs to the display converter 730. The recorder control unit 726 supplies the input EPG data to the EPG data memory 727 for storing.

The display converter 730 encodes the video data supplied from the video decoder 725 or recorder control unit 726 into, for example, the video data conforming to the NTSC (National Television Standards Committee) format using the video encoder 741, and outputs to the recording/playing unit 733. Also, the display converter 730 converts the size of the screen of the video data supplied from the video decoder 725 or recorder control unit 726 into the size corresponding to the size of the monitor 760. The display converter 730 further converts the video data of which the screen size has been converted into the video data conforming to the NTSC format using the video encoder 741, converts into an analog signal, and outputs to the display control unit 732.

The display control unit 732 superimposes, under the control of the recorder control unit 726, the OSD signal output from the OSD (On Screen Display) control unit 731 on the video signal input from the display converter 730, and outputs to the display of the monitor 760 for displaying.

Also, the audio data output from the audio decoder 724 has been converted into an analog signal using the D/A converter 734, and supplied to the monitor 760. The monitor 760 outputs this audio signal from the built-in speaker.

The recording/playing unit 733 includes a hard disk as a recording medium in which video data, audio data, and so forth are recorded.

The recording/playing unit 733 encodes the audio data supplied from the audio decoder 724 with the MPEG format by the encoder 751. Also, the recording/playing unit 733 encodes the video data supplied from the video encoder 741 of the display converter 730 with the MPEG format by the encoder 751. The recording/playing unit 733 synthesizes the encoded data of the audio data thereof, and the encoded, data of the video data thereof using the multiplexer. The recording/playing unit 733 amplifies the synthesized data thereof by channel coding, and writes the data thereof in the hard disk via a recording head.

The recording/playing unit 733 plays the data recorded in the hard disk, via a playing head, amplifies, and separates into audio data and video data using the demultiplexer. The recording/playing unit 733 decodes the audio data and video data by the decoder 752 using the MPEG format. The recording/playing unit 733 converts the decoded audio data from digital to analog, and outputs to the speaker of the monitor 760. Also, the recording/playing unit 733 converts the decoded video data from digital to analog, and outputs to the display of the monitor 760.

The recorder control unit 726 reads out the latest EPG data from the EPG data memory 727 based on the user's instructions indicated by the infrared signal from the remote controller which is received via the reception unit 721, and supplies to the OSD control unit 731. The OSD control unit 731 generates image data corresponding to the input EPG data, and outputs to the display control unit 732. The display control unit 732 outputs the video data input from the OSD control unit 731 to the display of the monitor 760 for displaying. Thus, EPG (Electronic Program Guide) is displayed on the display of the monitor 760.

Also, the hard disk recorder 700 can obtain various types of data such as video data, audio data, EPG data, and so forth supplied from another device via the network such as the Internet or the like.

The communication unit 735 is controlled by the recorder control unit 726 to obtain encoded data such as video data, audio data, EPG data, and so forth transmitted from another device via the network, and to supply this to the recorder control unit 726. The recorder control unit 726 supplies the encoded data of the obtained video data and audio data to the recording/playing unit 733, and stores in the hard disk, for example. At this time, the recorder control unit 726 and recording/playing unit 733 may perform processing such as re-encoding or the like according to need.

Also, the recorder control unit 72 6 decodes the encoded data of the obtained video data and audio data, and supplies the obtained video data to the display converter 730. The display converter 730 processes, in the same way as with the video data supplied from the video decoder 725, the video data supplied from the recorder control unit 726, supplies to the monitor 760 via the display control unit 732 for displaying an image thereof.

Alternatively, an arrangement may be made wherein in accordance with this image display, the recorder control unit 726 supplies the decoded audio data to the monitor 760 via the D/A converter 734, and outputs audio thereof from the speaker.

Further, the recorder control unit 726 decodes the encoded data of the obtained EPG data, and supplies the decoded EPG data to the EPG data memory 727.

The hard disk recorder 700 thus employs the decoding device 100 as the video decoder 725, decoder 752, and decoder housed in the recorder control unit 72 6. Accordingly, in the same way as with the decoding device 100, the video decoder 725, decoder 752, and decoder housed, in the recorder control unit 726 can decode images encoded so as to improve encoding efficiency in the case of performing intra prediction.

Also, the hard disk recorder 700 employs the encoding device 10 as the encoder 751. Accordingly, in the same way as with the case of the encoding device 10, the encoder 751 can improve encoding efficiency in the case of performing intra prediction.

Note that description has been made so far regarding the hard disk recorder 700 for recording video data and audio data in the hard disk, but it goes without saying that any kind of recording medium may be employed. For example, even with a recorder to which a recording medium other than a hard disk, such as flash memory, optical disc, video tape, or the like, is applied, the encoding device 10 and decoding device 100 can be applied thereto in the same way as with the case of the above hard disk recorder 700.

### [Configuration Example of Camera]

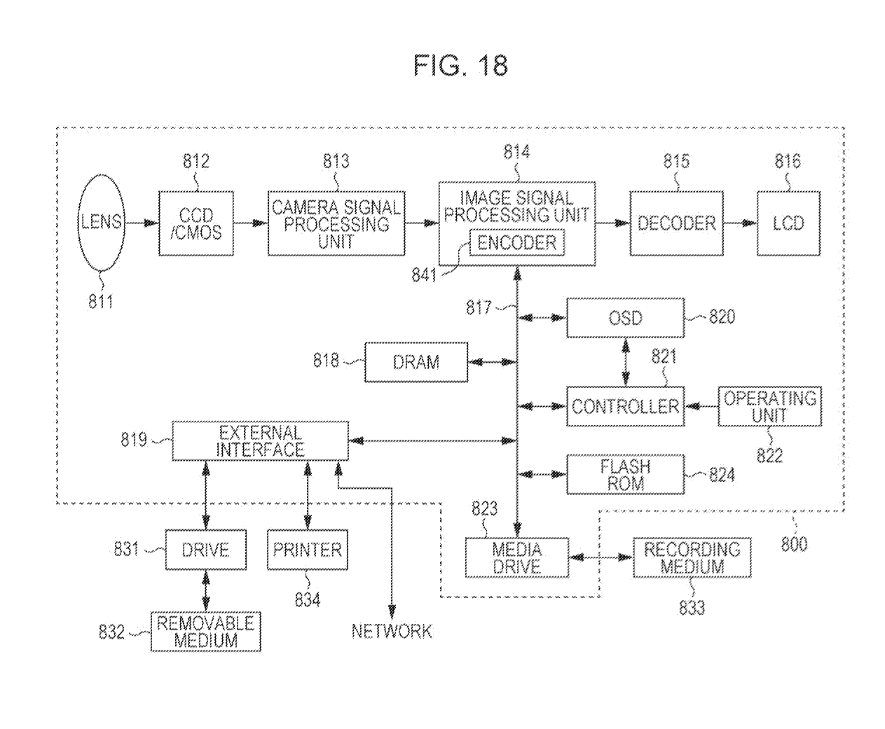

FIG. 18 is a block diagram illustrating a principal configuration example of a camera employing the encoding device and decoding device to which the present technology has been applied.

A camera 800 shown in FIG. 18 images a subject, displays an image of the subject on an LCD 816, and records this in a recording medium 833 as image data.

A lens block 811 inputs light (i.e., picture of a subject) to a CCD/CMOS 812. The CCD/CMOS 812 is an image sensor employing a CCD or CMOS, which converts the intensity of received light into an electrical signal, and supplies to a camera signal processing unit 813.

The camera signal processing unit 813 converts the electrical signal supplied from, the CCD/CMOS 812 into color difference signals of Y, Cr, and Cb, and supplies to an image signal processing unit 814. The image signal, processing unit 814 subjects, under the control, of a controller 821, the image signal supplied from the camera signal processing unit 813 to predetermined image processing, or encodes the image signal thereof by an encoder 841 using the MPEG format for example. The image signal processing unit 814 supplies encoded data generated by encoding an image signal, to a decoder 815. Further, the image signal processing unit 814 obtains data for display generated at an on-screen display (OSD) 820, and supplies this to the decoder 815.

With the above-described processing, the camera signal processing unit 813 appropriately takes advantage of DRAM (Dynamic Random Access Memory) 818 connected via a bus 817 to hold image data, encoded data encoded from the image data thereof, and so forth in the DRAM 818 thereof according to need.

The decoder 815 decodes the encoded data supplied from the image signal processing unit 814, and supplies obtained image data (decoded image data) to the LCD 816. Also, the decoder 815 supplies the data for display supplied from the image signal processing unit 814 to the LCD 816. The LCD 816 synthesizes the image of the decoded image data, and the image of the data for display, supplied from, the decoder 815 as appropriate, and displays a synthesizing image thereof.

The on-screen display 820 outputs, under the control of the controller 821, data for display such as a menu screen or icon or the like made up of a symbol, characters, or a figure to the image signal processing unit 814 via the bus 817.

Based on a signal indicating the content commanded by the user using an operating unit 822, the controller 821 executes various types of processing, and also controls the image signal processing unit 814, DRAM 818, external-interface 819, on-screen display 820, media drive 823, and so forth via the bus 817. Programs, data, and so forth necessary for the controller 821 executing various types of processing are stored in FLASH ROM 824.

For example, the controller 821 can encode image data stored in the DRAM 818, or decode encoded data stored in the DRAM 818 instead of the image signal processing unit 814 and decoder 815. At this time, the controller 821 may perform encoding/decoding processing using the same format as the encoding/decoding format of the image signal processing unit 814 and decoder 815, or may perform encoding/decoding processing using a format that neither the image signal processing unit 814 nor the decoder 815 can handle.

Also, for example, in the event that start of image printing has been instructed from the operating unit 822, the controller 821 reads out image data from the DRAM 818, and supplies this to a printer 8 34 connected to the external interface 819 via the bus 817 for printing.

Further, for example, in the event that image recording has been instructed from the operating unit 822, the controller 821 reads out encoded data from the DRAM 818, and supplies this to a recording medium 8 33 mounted on the media drive 823 via the bus 817 for storing.

The recording medium 833 is an optional readable/writable removable medium, for example, such as a magnetic disk, a magneto-optical disk, an optical disc, semiconductor memory, or the like. It goes without saying that the recording medium 833 is also optional regarding the type of a removable medium, and accordingly may be a tape device, or may be a disc, or may be a memory card. It goes without saying that the recoding medium 833 may be a non-contact IC card or the like.

Alternatively, the media drive 823 and the recording medium 833 may be configured so as to be integrated into a non-transportable recording medium, for example, such as a built-in hard disk drive, SSD (Solid State Drive), or the like.

The external interface 819 is configured of, for example, a USB input/output terminal and so forth, and is connected to the printer 834 in the event of performing printing of an image. Also, a drive 831 is connected to the external interface 819 according to need, on which the removable medium 832 such as a magnetic disk, optical disc, or magneto-optical disk is mounted as appropriate, and a computer program read out therefrom is installed in the FLASH ROM 824 according to need.

Further, the external interface 819 includes a network interface to be connected to a predetermined network such as a LAN, the Internet, or the like. For example, in accordance with the instructions from the operating unit 822, the controller 821 can read out encoded data from the DRAM 818, and supply this from the external interface 819 to another device connected via the network. Also, the controller 821 can obtain, via the external interface 819, encoded data or image data supplied, from another device via the network, and hold this in the DRAM 818, or supply this to the image signal processing unit 814.

The camera 800 thus configured employs the decoding device 100 as the decoder 815. Accordingly, in the same way as with the decoding device 100, the decoder 815 can decode images encoded so as to improve encoding efficiency in the case of performing intra prediction.

Also, the camera 800 employs the encoding device 10 as the encoder 841. Accordingly, in the same way as with the case of the encoding device 10, the encoder 841 can achieve higher encoding efficiency in the case of performing intra prediction.

Note that the decoding method of the decoding device 100 may be applied to the decoding processing which the controller 821 performs. In the same way, the encoding method of the encoding device 10 may be applied to the encoding processing which the controller 821 performs.

Also, the image data which the camera 800 takes may be moving images or may be still images.

As a matter of course, the encoding device 10 and decoding device 100 may be applied to devices and systems other than the above-described devices.

Note that embodiments of the present technology are not restricted to the above-described embodiment, and that various modifications may be made without departing from the essence of the present technology.

### REFERENCE SIGNS LIST

10 encoding device

13 computing unit

14 orthogonal transform unit

16 lossless encoding unit

41 candidate prediction image generating unit

43 prediction mode determining unit

45 intra skip determining unit

51 MostProbableMode generating unit

52 difference mode generating unit

101 storage buffer

102 lossless decoding unit

105 adding unit

123 prediction image generating unit

131 MostProbableMode generating unit

132 prediction mode reconstructing unit

1. An encoding device, comprising:
a prediction value generating unit configured to generate, using an optimal intra prediction mode of a peripheral block situated in the periphery of a current block which is the object of encoding, a prediction value for an optimal intra prediction mode of the current block;
a difference generating unit configured to generate the difference between the optimal intra prediction mode of the current block, and the prediction value of the optimal intra prediction mode of the current block, generated by the prediction value generating unit; and
a transmission unit configured to transmit the difference generated by the difference generating unit.

2. The encoding device according to claim 1, wherein the intra prediction modes of which the directions of the prediction images as to the current block are neighboring, are consecutive values.

3. The encoding device according to claim 1, wherein the transmission unit stops transmission of the difference, in the event that the difference generated by the difference generating unit is zero.

4. The encoding device according to claim 3, further comprising:
a generating unit configured, to generate difference between the current, block and the prediction image generated by the intra prediction processing of the optimal, intra prediction mode for the current block, as a residual image; and
an orthogonal transform unit configured to subject the residual image generated by the generating unit to orthogonal transform;
wherein the transmission unit transmits the difference, and a coefficient obtained as the result of the orthogonal transform, by the orthogonal, transform unit, and in the event, that the coefficient and the difference are zero, stops transmission of the coefficient and the difference.

5. The encoding device according to claim 1, wherein the prediction value generating unit generates the smallest of the optimal, intra prediction modes of a plurality of the peripheral blocks, as the prediction value of the optimal intra prediction mode of the current block.

6. The encoding device according to claim 1, wherein the transmission unit encodes and transmits the difference.

7. The encoding device according to claim 1, further comprising:
a prediction image generating unit configured to perform intra prediction processing of a plurality of intra prediction modes as to the current block, and generate a prediction image; and
a determining unit configured to determine a predetermined intra prediction mode out of the plurality of intra prediction modes, as the optimal intra prediction mode of the current block, based on the prediction image generated by the prediction image generating unit and the current block.

8. An encoding method of an encoding device, comprising:
a prediction value generating step to generate, using an optimal intra prediction mode of a peripheral block situated in the periphery of a current block which is the object of encoding, a prediction value for an optimal intra prediction mode of the current block;
a difference generating step to generate the difference between the optimal intra prediction mode of the current block, and the prediction value of the optimal intra prediction mode of the current block generated by processing in the prediction value generating step; and
a transmission step to transmit the difference generated by the processing in the difference generating step.

9. A decoding device, comprising:
a receiving unit configured to receive difference between an optimal intra prediction mode of a current block which is the object of decoding, and a prediction value of an optimal intra prediction mode of the current block generating using an optimal intra prediction mode of a peripheral block situated in the periphery of the current block;
a prediction value generating unit configured to generate a prediction value of the optimal mode of the current block, using the optimal intra prediction mode of the peripheral block; and
an intra prediction mode generating unit configured to generate the optimal intra prediction mode of the current block, by computing the difference received by the receiving unit and the prediction value of the optimal intra prediction mode of the current block, generated by the prediction value generating unit.

10. The decoding device according to claim 9, wherein the intra prediction modes of which the directions of the prediction images as to the current block are neighboring, are consecutive values.

11. The decoding device according to claim 9, wherein, in the event that the difference is zero, the encoding device stops transmission of the difference;
and wherein, in the event that the encoding device is to stop transmission of the difference, the intra prediction mode generating unit generates the prediction value of the optimal intra prediction mode of the current block generated by the prediction value generating unit as the optimal intra prediction mode of the current block.

12. The decoding device according to claim 11, further comprising:
a prediction image generating unit configured to perform intra prediction processing as to the current block, in the optimal intra prediction mode of the current block generated by the intra prediction mode generating unit, and generate a prediction image; and
an adding unit which decodes the current block by adding the prediction image generated by the prediction image generating unit and the current block;
wherein the encoding device transmits the difference and the current block, and in the event that the difference and the current block are zero, stops transmission of the difference and the current block;
and wherein, in the event of the encoding device stopping transmission of the current block, the adding unit, takes the prediction image generated by the prediction image generating unit as the decoding results of the current block.

13. The decoding device according to claim 9, wherein the prediction value generating unit generates the smallest of the optimal intra prediction modes of a plurality of the peripheral blocks as a prediction value of the optimal intra prediction mode of the current block.

14. The decoding device according to claim 9, further comprising:
a decoding unit configured to decode the encoded difference;
wherein the receiving unit receives the encoded, difference.

15. The decoding device according to claim 9, further comprising:
a prediction image generating unit configured to perform intra prediction processing on the current block, in an optimal inter prediction mode of the current block generated by the intra prediction mode generating unit, and generate a prediction image.

16. A decoding method of a decoding device, comprising:
a receiving step to receive difference between an optimal intra prediction mode of a current, block which is the object of decoding, and a prediction value of an optimal intra prediction mode of the current block generating using an optimal intra prediction mode of a peripheral block situated in the periphery of the current block;
a prediction value generating step to generate a prediction value of the optimal mode of the current block, using the optimal intra prediction mode of the peripheral block; and
an intra prediction mode generating step to generate the optimal intra prediction mode of the current block, by computing the difference received by the processing in the receiving step and the prediction value of the optimal intra prediction mode of the current block, generated by the processing of the prediction value generating step.
